(19) United States
(12) Patent Application Publication
(10) Pub. No.: US 2024/0338554 A1
(43) Pub. Date: Oct. 10, 2024

(54) SYSTEMS AND METHODS FOR GENERATING DESCRIPTIONS OF DATA SETS AND/OR MODELS

(71) Applicant: DataRobot, Inc., Boston, MA (US)

(72) Inventors: Michael Schmidt, Washington, DC (US); Marcus Braun, Minneapolis, MN (US); Ina Ko, Old Bridge, NJ (US); Alex Conway, Boston, MA (US)

(73) Assignee: DataRobot, Inc., Boston, MA (US)

(21) Appl. No.: 18/607,346

(22) Filed: Mar. 15, 2024

Related U.S. Application Data
(60) Provisional application No. 63/452,390, filed on Mar. 15, 2023.
(60) Provisional application No. 63/452,388, filed on Mar. 15, 2023.

(51) Int. Cl. G06N 3/0475; G06N 3/045; G06N 3/094

(52) U.S. Cl. CPC G06N 3/0475; G06N 3/045; G06N 3/094

(57) ABSTRACT

A method for generating a description of a data set may include generating a data dictionary that associates fields of the data set with descriptions of the fields based on analysis data and context data. The analysis data may indicate results of analysis of the data set including values of the fields and a value of an outcome variable. The context data may characterize a use case of the data set. The method may include generating a summary of the analysis data based on the analysis data and the dictionary; generating a description of a relationship between the outcome variable and a subset of the fields based on the context data, the summary of the analysis data, and the dictionary; generating a potential explanation for the relationship based on the context data and the description of the relationship; and outputting data based on the potential explanation.

### CROSS-REFERENCE TO RELATED APPLICATIONS

This application claims the benefit under 35 U.S.C. § 119(e) of U.S. Provisional Application No. 63/452,390, titled “Synthesizing natural language explanations of quantitative analysis plots” and filed Mar. 15, 2023 (Ref No. DRB-047-PR), and also claims the benefit under 35 U.S.C. § 119(e) of U.S. Provisional Application No. 63/452,388, titled “Generation of domain-aware prompts with machine learning” and filed Mar. 15, 2023 (Ref. No. DRB-046-PR), each of which is hereby incorporated by reference herein in its entirety.

### BACKGROUND AND MOTIVATION

Machine learning (“ML”) tools and artificial intelligence (“AI”) applications can be used to guide decision-making and/or to control systems in a wide variety of fields and industries, e.g., security; transportation; fraud detection; risk assessment and management; supply chain logistics; development and discovery of pharmaceuticals and diagnostic techniques; and energy management.

“Automated machine learning” technology may be used to automate significant portions of the process of developing machine learning (“ML”) tools and AI applications. In recent years, advances in automated machine learning technology have substantially lowered the barriers to the development of certain types of ML tools and AI applications, particularly those that make predictions or inferences based on statistical analysis of data. Historically, the processes used to develop ML tools and AI applications suitable for carrying out specific analytic tasks generally have been expensive and time-consuming, and often have required the expertise of highly-trained data scientists. Such processes generally includes steps of data collection, data preparation, feature engineering, model generation, and/or model deployment.

Recently, generative artificial intelligence (“Gen AI”) applications have been developed and commercialized. Gen AI technology has the ability to generate new and original content, including text, imagery, audio, source code, synthetic data, etc. Gen AI, driven by AI algorithms and advanced neural networks, empowers machines to go beyond traditional rule-based programming and engage in autonomous, creative decision-making. By leveraging vast amounts of data and the power of machine learning, Gen AI algorithms can generate new content, simulate human-like behavior, and even compose music, write code, and create visual art.

### SUMMARY

According to an aspect of the present disclosure, a computer-implemented method includes: obtaining analysis data indicating a plurality of results of analysis of a data set, the data set including a plurality of records, each record in the plurality of records including values of one or more respective fields and a value of an outcome variable; obtaining context data that characterizes a use case of the data set; generating, using one or more generative models, based on the analysis data and the context data, a data dictionary that associates each field in the one or more fields with a respective description of the field; generating, using the one or more generative models, based on the analysis data and the data dictionary, a summary of the analysis data; generating, using the one or more generative models, based on the context data, the summary of the analysis data, and the data dictionary, a description of a relationship between the outcome variable and at least a subset of the one or more fields; generating, using the one or more generative models, based on the context data and the description of the relationship, one or more potential explanations for the relationship; and outputting, for presentation via a user interface, output data based on the one or more potential explanations.

According to another aspect of the present disclosure, a system includes at least one processor and a computer-readable storage medium storing computer-executable instructions that, when executed by the at least one processor, cause the at least one processor to performing operations including: obtaining analysis data indicating a plurality of results of analysis of a data set, the data set including a plurality of records, each record in the plurality of records including values of one or more respective fields and a value of an outcome variable; obtaining context data that characterizes a use case of the data set; generating, using one or more generative models, based on the analysis data and the context data, a data dictionary that associates each field in the one or more fields with a respective description of the field; generating, using the one or more generative models, based on the analysis data and the data dictionary, a summary of the analysis data; generating, using the one or more generative models, based on the context data, the summary of the analysis data, and the data dictionary, a description of a relationship between the outcome variable and at least a subset of the one or more fields; generating, using the one or more generative models, based on the context data and the description of the relationship, one or more potential explanations for the relationship; and outputting, for presentation via a user interface, output data based on the one or more potential explanations.

According to another aspect of the present disclosure a computer-implemented method includes: receiving a request to generate computer-executable operations for use with machine learning on a data set; identifying contextual data related the request based on metadata and the received request; constructing a prompt including the contextual data and the request, wherein the contextual data identify a programming language and an application programming interface; providing the prompt as input to an application programming interface for one or more generative models; receiving, as output from the one or more generative models, the computer-executable operations corresponding to the request; and outputting, for presentation via a user interface, output data representing the computer-executable operations.

According to another aspect of the present disclosure, a computer-implemented method includes: obtaining analysis data indicating a plurality of results of analysis of a data set, the data set including a plurality of records, each record in the plurality of records including values of one or more respective fields and a value of an outcome variable; obtaining context data that characterizes a use case of the data set; generating, using one or more generative models, based on the analysis data and the context data, a data dictionary that associates each field in the one or more fields with a respective description of the field; and outputting, for presentation via a user interface, output data based on the respective descriptions of the one or more fields.

According to another aspect of the present disclosure, a computer-implemented method includes: obtaining analysis data indicating a plurality of results of analysis of a data set, the data set including a plurality of records, each record in the plurality of records including values of one or more respective fields and a value of an outcome variable; obtaining context data that characterizes a use case of the data set; generating, using one or more generative models, based on the analysis data and the context data, a data dictionary that associates each field in the one or more fields with a respective description of the field; generating, using the one or more generative models, based on the analysis data and the data dictionary, a summary of the analysis data; and outputting, for presentation via a user interface, output data based on the summary of the analysis data.

According to another aspect of the present disclosure, a computer-implemented method includes: obtaining analysis data indicating a plurality of results of analysis of a data set, the data set including a plurality of records, each record in the plurality of records including values of one or more respective fields and a value of an outcome variable; obtaining context data that characterizes a use case of the data set; generating, using one or more generative models, based on the analysis data and the context data, a data dictionary that associates each field in the one or more fields with a respective description of the field; generating, using the one or more generative models, based on the analysis data and the data dictionary, a summary of the analysis data; generating, using the one or more generative models, based on the context data, the summary of the analysis data, and the data dictionary, a description of a relationship between the outcome variable and at least a subset of the one or more fields; and outputting, for presentation via a user interface, the description of the relationship between the outcome variable and at least a subset of the one or more fields.

The foregoing is a non-limiting summary of the invention, which is defined by the attached claims.

### BRIEF DESCRIPTION OF THE DRAWINGS

These and other aspects and features of this disclosure will become apparent to those ordinarily skilled in the art upon review of the following description of specific implementations in conjunction with the accompanying figures, wherein:

FIG. 1 is a block diagram of an example system for generating descriptions of data sets and/or models.

FIG. 2 is a data flow diagram of an example method for generating descriptions of data sets and/or models.

FIG. 3 is a flow diagram of an example method for generating descriptions of data sets and/or models.

FIG. 4 is a block diagram of an example method for generating a data dictionary.

FIG. 5 is an illustration showing an example user interface displaying analysis data.

FIG. 6 is a block diagram of an example method for generating a data summary.

FIG. 7 is a block diagram of an example method for generating relationship descriptions.

FIG. 8 is an illustration showing an example user interface for displaying feature impact data.

FIG. 9 is an illustration showing an example user interface displaying analysis data in conjunction with explanations for trends in the analysis data.

FIG. 10 is a block diagram of an example method for generating potential explanations for relationships observed in a data set.

FIG. 11 is an illustration showing examples of potential explanations for relationships observed in a data set.

FIG. 12 is a block diagram showing an example method for generating responses to user-provided queries regarding a data set or model.

FIG. 13 is an illustration of an example user interface showing an output generated in response to a user-provided query.

FIG. 14 is a block diagram of an example method for generating prediction explanation summaries.

FIG. 15 is an illustration of an example plot of prediction explanations.

FIG. 16 is an illustration of an example user interface showing a summary of a plot of prediction explanations.

FIG. 17 is an illustration of an example user interface showing a word cloud plot of data values.

FIG. 18 is a block diagram of an example machine learning model development system.

FIG. 19 is a block diagram of an example feature engineering module that functions as part of an example machine learning model development system.

FIG. 20 is a block diagram of an example machine learning model deployment system.

FIG. 21 is a block diagram of an example computing system capable of implementing the principles described herein.

### DETAILED DESCRIPTION

### Introduction

The present disclosure describes examples of systems and methods for generating descriptions (e.g., natural-language descriptions) of data sets (e.g., quantitative analysis plots of data sets) and/or models (e.g., machine-learning models) using a generative model (e.g., a language model). As various forms of quantitative analysis grow in everyday usage, so too grows the need for quick and efficient ways to interpret data processed and/or created by models. As described in greater detail below, generative models can be used to generate descriptions of quantitative analysis that can aid data analysts or even lay individuals in understanding the quantitative analysis results, the underlying data, and/or the related models. In some examples, a quantitative analysis can be performed as part of a modeling process (e.g., a predictive modeling process). For example, predictive modeling can be used to estimate a probability that a particular patient at a hospital will be readmitted within a certain time frame, or to calculate a likelihood that a particular business will default on a loan among other use cases.

In these and other contexts, some embodiments of the systems and methods described herein can transform the quantitative analysis data and related information into data structures (e.g., prompts) suitable for prompting generative models to accurately describe a variety of relationships between variables in the data set as well as explanations for why these relationships might exist. In some cases, these relationships can be generalized across the data set, generalized to one or more models, or even applied to individual predictions of individual models.

Though powerful, existing generative models often have a propensity to hallucinate (e.g., produce erroneous results) or generate content that is not responsive to a prompt. The inventors have recognized and appreciated that, in many cases, generative models can provide accurate, relevant descriptions of quantitative analysis data if appropriate information derived from the quantitative analysis data is provided to the generative model as part of the prompt (e.g., as “contextual information” or “context” in the prompt). In some cases, the format or structure of such contextual information in the prompt has a significant impact on the accuracy and relevance of the generative model's response.

Described herein are numerous examples of techniques for constructing prompts suitable for eliciting accurate and relevant descriptions of quantitative analysis data from a generative model. For example, described herein are examples of (1) novel techniques for constructing dictionary prompts suitable for prompting a generative model to generate descriptions of the variables of a data set; (2) novel techniques for constructing summary prompts suitable for prompting a generative model to generate a summary of one or more portions of the analysis data; (3) novel techniques for constructing relationship prompts suitable for prompting a generative model to generate descriptions of relationships between variables within a data set; and (4) novel techniques for constructing relationship explanation prompts suitable for prompting a generative model to generate potential explanations for the observed relationships between variables within a data set. Also described herein are examples of techniques for using two or more of the foregoing prompting techniques in combination to prompt generative models to provide executive summaries of data sets, engage with human users in question and answer (“Q&A”) style interaction, etc.

Some embodiments of the systems and methods described herein may accordingly improve the functioning of data analysis systems by allowing these systems to provide human analysts with information in a natural language (e.g., conversant) format as well as generate a variety of concise data summaries that are accessible to both data specialists and non-specialists. In some examples, the systems and methods described herein can also provide insights as to how and why a predictive model arrived at a particular conclusion. In some examples, the systems and methods described herein may also improve data analysis systems by allowing those systems to engage with human users in a “Q&A” style interaction and analysis of the data.

Some examples are described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations are described, and detailed descriptions of other portions of such known components are omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, terms in the specification or claims should not be ascribed an uncommon or special meaning unless explicitly set forth as such.

### Generative AI

Gen AI technology is quickly impacting diverse industries and sectors, from healthcare and finance to manufacturing and entertainment. For example, Gen AI has shown promising results in information retrieval, question answering, computer vision, natural language processing, content generation (text, images, video, software code, music, audio, etc.), software development, healthcare (e.g., predicting protein structures, identifying drug candidates), motion control and navigation (e.g., for autonomous robots), and other domains. However, existing Gen AI technology often has significant problems with bias and accuracy, and a propensity to hallucinate (e.g., produce erroneous results) or generate content having low relevance to the user's prompt (e.g., content in a different language, or content that is not responsive to the prompt).

Gen AI technology generally utilizes techniques such as Generative Adversarial Networks (GANs), transformer-based models, diffusion models (e.g., stable diffusion models), and/or Variational Autoencoders (VAEs), etc., which are based on artificial neural networks and deep learning. Deep Learning (DL) is a subset of ML that focuses on artificial neural networks (ANN) and their ability to learn and make decisions. Deep Learning involves the use of complex algorithms to train ANNs to recognize patterns and make predictions based on large amounts of data. DL algorithms can learn multiple layers of representations, allowing them to model highly nonlinear relationships in the data. This makes them particularly effective for applications such as image and speech recognition, natural language processing (NPL), etc.

Most DL methods use ANN architectures, which is why DL models are often referred to as deep neural networks (DNNs). The term “deep” refers to the number of hidden layers in the neural network. For example, a traditional ANN may only contain 2-3 hidden layers, while DNNs can have as many as 150 layers (or more). DL uses these multiple layers to progressively extract higher-level features from the raw input. For example, in image processing, lower layers may identify edges, while higher layers may identify the concepts relevant to a human, such as digits or letters or faces. DL models are trained by using large sets of labeled data and ANN architectures that learn features directly from the data without the need for manual feature extraction.

In many Gen AI applications, the DNN that generates content is a large language model (LLM). A large language model (LLM) is a type of ML model that can perform a variety of natural language processing (NLP) tasks such as generating and classifying text, answering questions in a conversational manner, and translating text from one language to another. The term ‘large’ refers to the number of values (parameters) the language model can change autonomously as it learns. Some LLMs have hundreds of billions of parameters. In general, LLMs are NN models that have been trained using deep learning techniques to recognize, summarize, translate, predict, and generate content using very large datasets.

Many LLMs use a class of deep learning architectures called transformer neural networks (“transformer networks” or “transformers”). A transformer is a neural network that learns context and meaning by tracking relationships between data units, such as the words in a sentence. A transformer can include multiple transformer blocks, also known as layers. For example, a transformer may have self-attention layers, feed-forward layers, and normalization layers, all working together to decipher input to predict (or generate) streams of relevant output. The layers can be stacked to make deeper transformers and powerful language models.

Two innovations that make transformers particularly adept for large language models are positional encodings and self-attention. Positional encoding embeds the order in which the input occurs within a given sequence. Rather than feeding words within a sentence sequentially into the neural network, with positional encoding, the words can be fed in non-sequentially. Self-attention assigns a weight to each part of the input data while processing it. This weight signifies the importance of that portion of the input in the context of the rest of the input. The use of the attention mechanism enables models to focus on the parts of the input that matter the most. This representation of the relative importance of different inputs to the neural network is learned over time as the model sifts and analyzes data. These two techniques in conjunction allow for analyzing the subtle ways and contexts in which distinct elements influence and relate to each other over long distances, non-sequentially. The ability to process data non-sequentially enables the decomposition of the complex problem into multiple, smaller, simultaneous computations.

“Text completion” refers to the process of a generative model generating additional text based on provided text, e.g., providing the next word in a sentence. The additional text provided by the generative model may be referred to herein as a “completion.” “Prompting” is a technique in which an LLM is matched to a desired downstream task by formulating the task as natural language text explaining the desired behavior, such that a generative model can carry out the task by performing text completion. Often these instructions are split into a “system message” containing general task instructions providing general guidance about the desired behavior and a “prompt template” containing the portion of the prompt that contains indicator values that are substituted in each use. “Fine-tuning” refers to the process whereby a generative model is adapted to a particular task by changing its parameters by providing prompts with desired completions.

Generative AI models can analyze existing content, identify patterns in the content, and combine or modify the identified patterns to generate new content. The new content can include text, images, video, music, or any other suitable type of content. Some non-limiting examples of generative AI models include generative adversarial networks (GANs), variational autoencoders (VAEs), autoregressive models (e.g., large language models (LLMs)), recurrent neural networks (RNNs), transformer-based models, reinforcement learning models for generative tasks, etc. Transformer-based models generally have an encoder-decoder architecture, use an attention mechanism (e.g., scaled dot-product attention, multi-head attention, masked attention, etc.) to model the relationships between different elements in a sequence of content, and perform well when processing long sequences of content. Some non-limiting examples of transformer-based models include Generalized Pre-trained Transformer 4 (GPT-4), DALL-E3, etc. Other examples of generative models with text-processing capability include Jurassic-1, Command, and Paradigm.

### Terms

The term “natural language” as used herein may generally refer to language that has developed naturally over the course of human usage, or any language structure that occurs naturally in a human community by process of use. For example, conversational English may be one example of a natural language. Natural languages are distinguished from constructed or formal languages, such as those used to program computers or to describe mathematical logic.

The term “generative model” as used herein may generally refer to a type of machine learning model that is trained on existing data to enable the generative model to generate, based on an input or prompt, new data that shares characteristics similar to that of the training data. In some examples, a generative model may handle text. In these examples, the generative model may accept text prompts and produce text outputs. Any suitable type of AI model can be used, including predictive models, generative AI (“Gen AI”) models, etc. Predictive models can analyze historical data, identify patterns in that data, and make inferences (e.g., produce predictions or forecast outcomes) based on the identified patterns. Some non-limiting examples of predictive models include neural networks (e.g., deep neural networks (DNNs), convolutional neural networks (CNNs), recurrent neural networks (RNNs), learning vector quantization (LVQ) models, etc.), regression models (e.g., linear regression models, logistic regression models, linear discriminant analysis (LDA) models, etc.), decision trees, random forests, support vector machines (SVMs), naïve Bayes models, classifiers, etc.

The term “data analytics” as used herein may refer to the process of analyzing data (e.g., using machine learning models or techniques) to discover information, draw conclusions, and/or support decision-making. Species of data analytics can include descriptive analytics (e.g., processes for describing the information, trends, anomalies, etc. in a data set), diagnostic analytics (e.g., processes for inferring why specific trends, patterns, anomalies, etc. are present in a data set), predictive analytics (e.g., processes for predicting future events or outcomes), and prescriptive analytics (processes for determining or suggesting a course of action).

The term “machine learning” as used herein may refer to the application of certain techniques (e.g., pattern recognition and/or statistical inference techniques) by computer systems to perform specific tasks. Machine learning techniques (automated or otherwise) may be used to build data analytics models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

A feature of a data sample may be a measurable property of an entity (e.g., person, thing, event, activity, etc.) represented by or associated with the data sample. In some cases, a feature of a data sample is a description of (or other information regarding) an entity represented by or associated with the data sample. A value of a feature may be a measurement of the corresponding property of an entity or an instance of information regarding an entity. In some cases, a value of a feature can indicate a missing value (e.g., no value). For instance, in the above example in which a feature is the price of a house, the value of the feature may be ‘NULL’, indicating that the price of the house is missing.

Features can also have data types. For instance, a feature can have a numerical data type, a categorical data type, a time-series data type, a text data type (e.g., a structured text data type or an unstructured (“free”) text data type), an image data type, a spatial data type, or any other suitable data type. In general, a feature's data type is categorical if the set of values that can be assigned to the feature is finite.

The term “partial dependence” as used herein may refer to how a particular feature affects an outcome, prediction, or target variable. Partial dependence values or plots may show magnitude and/or directionality of a feature's impact on the target variable. In some embodiments, the relationship between the feature and target variable can be linear, monotonic, etc. Partial dependence of a feature can be determined in a variety of ways. In some embodiments, partial dependence can be determined by changing the value of the feature of interest and holding the values of other variables (e.g., inputs to the model) constant.

Data (e.g., variables, features, etc.) having certain data types, including data of the numerical, categorical, or time-series data types, may be organized in tables for processing by machine-learning tools. Data having such data types may be referred to collectively herein as “tabular data” (or “tabular variables,” “tabular features,” etc.). Data of other data types, including data of the image, textual (structured or unstructured), natural language, speech, auditory, or spatial data types, may be referred to collectively herein as “non-tabular data” (or “non-tabular variables,” “non-tabular features,” etc.).

As used herein, “data analytics model” may refer to any suitable model artifact generated by the process of using a machine learning algorithm to fit a model to a specific training data set. The terms “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

As used herein, a “modeling blueprint” (or “blueprint”) refers to a computer-executable set of preprocessing operations, model-building operations, and postprocessing operations to be performed to develop a model based on the input data. Blueprints may be generated “on-the-fly” based on any suitable information including, without limitation, the size of the user data, features types, feature distributions, etc. Blueprints may be capable of jointly using multiple (e.g., all) data types, thereby allowing the model to learn the associations between image features, as well as between image and non-image features.

Generating Explanations of Data Sets and/or Models

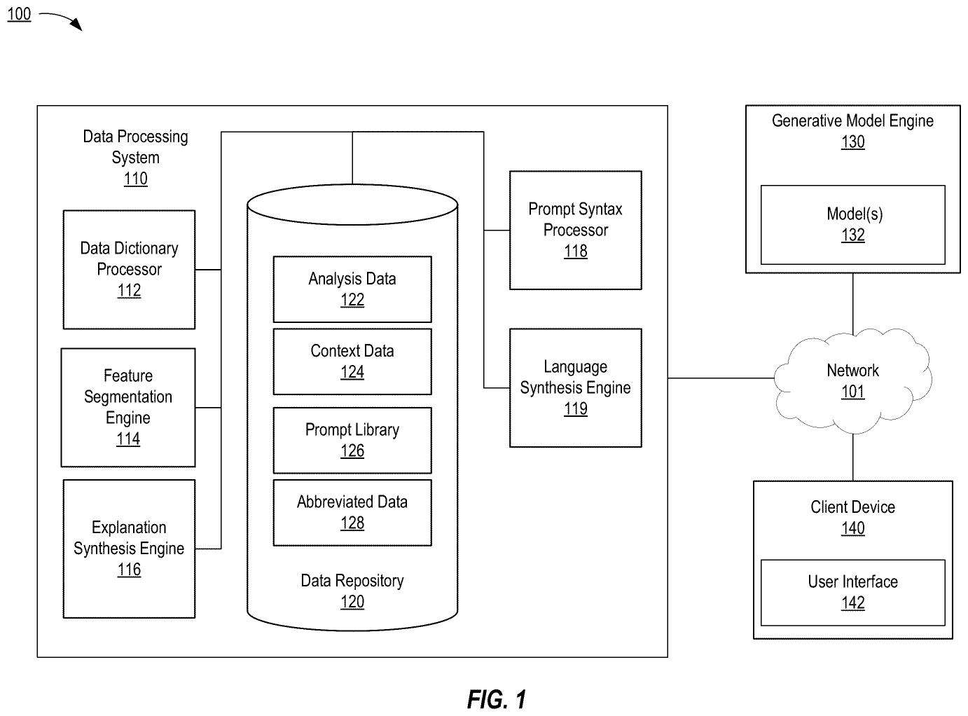

FIG. 1 is a block diagram of an example system 100 for synthesizing descriptions (e.g., natural language descriptions, which may include natural language explanations) of a quantitative analysis data set and/or a machine-learning model. System 100 includes a data processing system 110, a generative model engine 130 including model(s) 132, and a client device 140 including a user interface 142. The data processing system 110, the generative model engine 130, and the client device 140 may communicate with one another via a network 101. For example, the data processing system 110 may transmit a prompt to generative model engine 130 via the network 101, generative model engine 130 may provide the prompt to model 132, and model 132 may generate output (e.g., natural language output) based on the prompt. Generative model engine 130 may then transmit the output of model 132 to data processing system 110 via network 101.

Generative model engine 130 can be implemented by a third-party service using an open source artificial intelligence and/or machine learning platform, including one or more model(s) that are trained to output computer-executable operations for machine learning tasks (e.g., data science code) based on a string of natural language text that describes the requested code and/or machine learning tasks. In some embodiments, generative model engine 130 can be or include a large language engine (LLE).

Data processing system 110 may communicate with external devices including but not limited to a client device 140 (e.g., a smartphone, mobile device, wearable mobile device, tablet computer, desktop computer, laptop computer, cloud server, etc.) but, without regard to the client device 140, data processing system 110 may communicate with one or more of a smartphone, mobile device, wearable mobile device, tablet computer, desktop computer, laptop computer, cloud server, local server, and the like.

Data processing system 110 may include a physical processor and a non-transitory, computer-readable medium including instructions which, when executed by the processor, cause the processor to perform operations discussed herein. Data processing system 110 may receive input from the user interface 142 regarding quantitative analysis. Data processing system 110 may use the received input and data associated with the quantitative analysis to create generative model prompts to submit to model 132. The generative model prompts may be configured to produce observations and/or explanations of various trends or other features of the quantitative analysis.

Data processing system 110 may include a data repository 120. Data repository 120 may include analysis data 122, representing information produced by a quantitative analysis project. For example, the target data 122 may be hospital patient data and the quantitative analysis may be an analysis of patient readmission. In this example, the quantitative analysis may also include predictive modeling aspects that predict the probability of patient readmission, whether as an overall percentage of the hospital's patients or the probability that a specific patient will be readmitted to the hospital within a specified timeframe.

Data repository 120 may include context data 124. Context data 124 may include a context of the quantitative analysis, which in some embodiments may be provided by a data scientist or other user of data processing system 110. Context data 124 may include a natural language description of the quantitative analysis and/or a goal, quantitative approach, and/or intended audience of the quantitative analysis. For example, context data 124 may indicate that the quantitative analysis is generated to analyze hospital patient data and specifically to analyze the probability of patient readmission. In some embodiments, context data 124 is a natural language description of a purpose or goal of the quantitative analysis. In the above-described example of patient readmission, context data 124 indicates that the quantitative analysis examines factors contributing to 30-day hospital patient readmissions. As a particularly specific example, context data 124 may be a text string stating “Hospital readmission rates. We are predicting whether or not a patient will be readmitted to the hospital within 30 days.”

Data repository 120 may include a prompt library 126. Prompt library 126 may include one or more prompts, prompt components, prompt templates, or prompt structures for constructing a generative model prompt. For example, prompt library 126 may include a template for a dictionary prompt for generating a data dictionary based on parameters of a quantitative analysis. This template may include static portions that remain constant across all uses of the template as well as customizable portions to be replaced by text or other information specific to a particular quantitative analysis, such as context data 124, summaries of various features derived from analysis data 122, outputs of feature segmentation engine 114 and/or explanation synthesis engine 116, or any other data specific to a particular quantitative analysis project.

Data repository 120 may include abbreviated data 128. Abbreviated data 128 may include summaries of data associated with the quantitative analysis. In an example, the context data 128 includes abbreviations of terms used in the quantitative analysis. In a further example, abbreviated data includes natural language summarizations of aspects of analysis data 122, such as summarizations of feature impact data, summarizations of partial dependence data, summarizations of word cloud data, or other summarizations of analysis data 122.

Data processing system 110 may include a data dictionary processor 112 configured to generate a first generative model prompt for generating a data dictionary based on the quantitative analysis. As will be described in greater detail below, data dictionary processor 112 may identify parameter names used in the quantitative analysis and generate the first generative model prompt to generate natural language descriptions of the identified parameters. In some embodiments, data dictionary processor 112 may identify top features of the data analysis (e.g., by using abbreviated data 128) and identify parameter names associated with the top features or those that contribute most strongly to an outcome variable defined in analysis data 122 (e.g., 30-day patient readmission rates. In some embodiments, data dictionary processor 112 may identify a plot (e.g., a feature impact plot, a partial dependence plot, and/or a word cloud) associated with the quantitative analysis and identify parameter names of parameters and/or variables used in the plot. In one example, data dictionary processor 112 identifies variable names, a title, and/or axis descriptions of a plot generated in the quantitative analysis. As a specific example, data dictionary processor 112 can identify features indicated in a feature impact plot along with the features' respective impacts on the associated target variable.

Data dictionary processor 112 may use a dictionary request prompt template from the prompt library 126 to generate the first generative model prompt. The data dictionary processor 112 may use context data 124 to generate the first generative model prompt. The data dictionary processor 112 may combine the parameter names identified as above, the dictionary request prompt template, and context data 124 to generate the first generative model prompt and provide the prompt to generative model engine 130. In response, model 132 may use the provided prompt to generate natural language descriptions of the identified parameters. In some embodiments, data dictionary processor 112 may iteratively create generative model prompts for each of the identified parameters. In these embodiments, data dictionary processor 112 may submit a first prompt that includes the template retrieved from prompt library 126, context data 124, and a line or prompt portion for a first identified parameter. Once data dictionary processor 112 receives the response from generative model engine 130 with the natural language description of the first parameter, data dictionary processor 112 may append that response to the previously used prompt, add a line or prompt portion for a second parameter, and submit the new prompt back to generative model engine 130. Data dictionary processor 112 may repeat this process until all relevant parameters have been associated with relevant natural language descriptions by generative model engine 130. In some embodiments, the data dictionary is added to abbreviated data 128.

Data processing system 110 may include a feature segmentation engine 114 configured to generate a second generative model prompt for generating natural language observations of features of the quantitative analysis. As will be described in greater detail below, feature segmentation engine 114 may modify plot data from the quantitative analysis used to generate a descriptive plot related to the quantitative analysis (e.g., a feature impact, partial dependence, or word cloud plot) and generate a markdown table or other summary of the plot data using the modified data. In some embodiments, feature segmentation engine 114 may abbreviate the plot data to limit a size of the markdown table or other summarization. In these embodiments, feature segmentation engine 114 may abbreviate the plot data by selecting the most impactful features of analysis data 122, semi-randomly select features, or select features by any appropriate method to limit the total number of features presented to generative model engine 130 to reduce a probability of hallucinations produced by model 132.

The feature segmentation engine 114 may use the markdown table or other summarization to generate the second generative model prompt. The feature segmentation engine 114 may use the data dictionary created by data dictionary processor 112 and/or the context data 124 to generate the second generative model prompt. In some embodiments, the feature segmentation engine 114 may use a summary request prompt template from the prompt library 126 to generate the second generative model prompt. The feature segmentation engine 114 may combine the markdown table, the data dictionary, the summary request prompt, and/or context data 124 using the template to generate the second generative model prompt. The feature segmentation engine 114 may submit the second generative model prompt to the model 132 to generate one or more natural language observations or factual statements regarding the quantitative analysis. The observations and/or statements may describe relationships between variables of the plot. In one example, the features segmentation engine 114 submits the second generative model prompt to the model 132 to generate summaries of correlations between patient variables and 30-day hospital patient readmissions.

Data processing system 110 may include an explanation synthesis engine 116 configured to generate a third generative model prompt for generating natural language explanations or hypotheses regarding the quantitative analysis. As will be described in greater detail below, explanation synthesis engine 116 may use an explanation synthesis prompt template from the prompt library 126 and populate the template using context data 124 and/or the natural language observations generated by feature segmentation engine 114 to create the third generative model prompt. In some embodiments, explanation synthesis engine 116 generates generative model prompts for each of the observations created by feature segmentation engine 114 which can be submitted to generative model engine 130 either sequentially or in parallel. Explanation synthesis engine 116 submits the third generative model prompt to the model 132 to generate a natural language hypothesis or explanation regarding the plot, which may include a proposed cause for the natural language observations and/or the observed features in the plot. The natural language hypothesis may include a proposed explanation of an observed feature in the plot using terms and concepts from the data dictionary.

In some embodiments, data processing system 110 may include a prompt syntax processor 118 configured to generate a fourth generative model prompt based on user input for generating a natural language response to the user input. The syntax processor 118 may receive the user input from the user interface 142 and determine that the user input includes a question or request regarding the plot. The syntax processor 118 may generate the fourth generative model prompt to cause generative model engine 130 to generate a natural language answer to the user input. The syntax processor may use context data 124, the natural language explanations generated by explanation synthesis engine 116, the statements or observations generated by feature segmentation engine 114, and/or the data dictionary created by data dictionary processor 112 along with a prompt template retrieved from prompt library 126 to generate the prompt. Prompt syntax processor 118 may use also use intermediate prompts, such as a recap prompt created from one or more of the above-described inputs, a transcript of user input and responses from the data processing system 110 and/or the model 132, a query prompt from prompt library 126, and/or the user input to generate the fourth generative model prompt. The syntax processor 118 may submit the fourth generative model prompt to the model 132 to generate the natural language response to the user-provided input.

In some examples, data processing system 110 may include a language synthesis engine 119 configured to generate a fifth generative model prompt for pairing natural language observations of the plot in association with natural language hypotheses for why certain features are present in the analysis data. The language synthesis engine 119 may use context data 124, the natural language relationships identified by feature segmentation engine 114, and/or previously generated natural language hypotheses or explanations to generate a recap prompt. The language synthesis engine 119 may use the recap prompt and a relationship summary prompt to generate relationship summaries, which in turn may be fed into an explanation synthesis prompt. In some embodiments, the language synthesis engine 119 generates relationship summary prompts for each relationship or factual statement identified in the steps described in greater detail above. The language synthesis engine 119 may submit the relationship summary prompt to the model 132 to generate a natural language relationship summary. The language synthesis engine 119 may use the natural language relationship summary, the context data 124, and/or an explanation synthesis prompt template retrieved from prompt library 126 to generate a fifth generative model prompt that can be submitted to model 132 to generate natural language relationship-explanation pairings wherein a given observation or feature relationship is paired with an associated explanation for why the relationship exists in the quantitative analysis data. In one particular example, the natural language explanation of a plot related to 30-day hospital patient readmission can include an observation of a correlation between a patient variable such as a number of previous inpatient visits and 30-day hospital patient readmission as well as a hypothesis explaining a cause of the correlation to explain the observation.

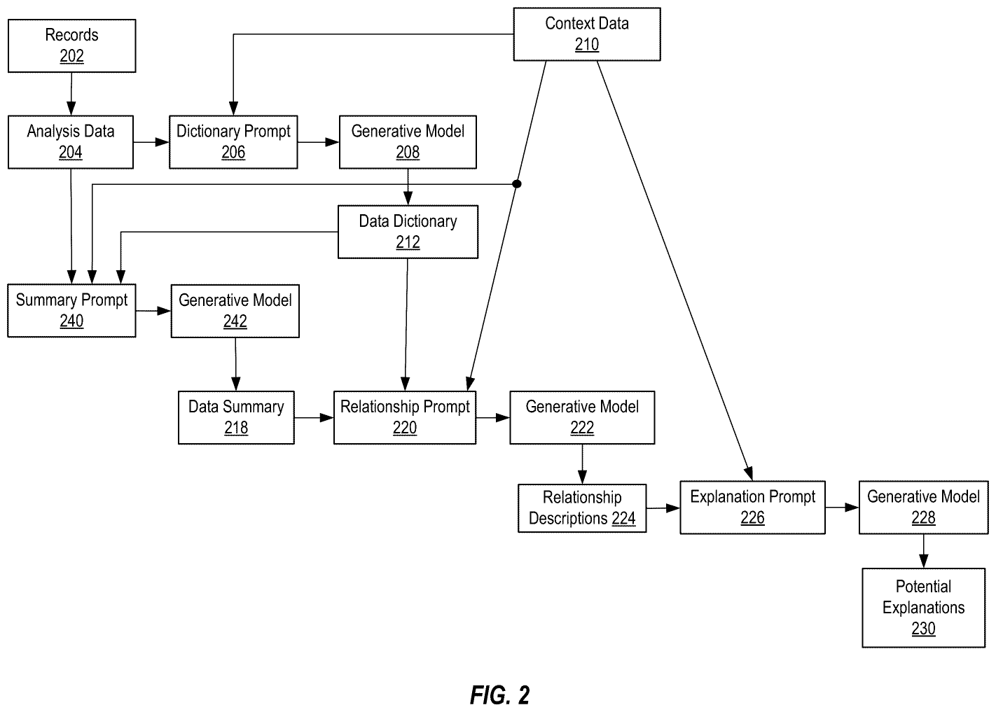

FIG. 2 is a block diagram showing how a system (e.g., system 100) can use data, prompts, and generative models to produce descriptions (e.g., natural language observations and/or explanations) of quantitative analysis data and/or a model. Referring to FIG. 2, a system may obtain analysis data 204, which indicates results of an analysis of a data set. The data set can include records 202, and each of the records 202 can include values of one or more respective features (e.g., fields) and a value or indication of a target variable. In the case of predictive modeling scenarios, the value of the target variable can be a probability, e.g., the probability of a particular predicted outcome such as the patient readmission rates described above. The system can also obtain context data 210, which characterizes a use case of the data set. In some embodiments, context data 210 can include a short natural language description of the intended use case for the analysis of the data set, such as “predicting patient readmission rates.”

Analysis data 204 and context data 210 can be used in conjunction with a dictionary prompt template to create a dictionary prompt 206. The system can submit one or more dictionary prompts 206 to a generative model 208 to prompt the generative model to generate data dictionary 212. Data dictionary 212 can include a variety of information and be created in a variety of ways. In general, a data dictionary includes field names (e.g., field “labels”) or other indicia of rows or columns in the original data set, with each entry associated with a description (e.g., natural language description) of the corresponding field. Such a dictionary can be generated using an iterative process. In one specific example of an iterative data dictionary generation process, the systems and methods described herein may iterate across the field labels (e.g., column labels) used in a quantitative analysis data set. A field label may be provided to an LLM or other generative model as part of a prompt tailored to cause the generative model to generate a description (e.g., natural language description) of the field. The response received from the generative model may then be appended to the prompt along with the next field label to be described. Eventually, the prompt can include each field label in the data set along with a generative model-generated description of the field. As a specific example, field labels in a data set related to loans and loan repayment can include entries such as “annual_inc” and “int_rate.’A generative model can generate natural language descriptions of these fields, such as “this field represents the annual income of the loan customer” and “this field contains the interest rate of the loan,” respectively. Data dictionary 212 can then be used in future processing steps for producing the explanations of analysis data 204, as described below.

In some embodiments, context data 210, analysis data 204 and data dictionary 212 can be used to create a summary prompt 240, which in turn can be provided to a generative model 242 to prompt the generative model to generate a data summary 218. Data summaries may be plot-specific. For example, a separate data summary may be created for each analysis plot derived from (or included in) analysis data 204. As a specific example, analysis data 204 may include a feature impact plot, a partial dependence plot, a prediction explanation plot, and/or a word cloud plot. In some embodiments, the system may analyze the plots (or the underlying plot data) to generate text-based markdown tables representing the plot data, which can then be included in future prompts to the generative model 208. The systems and methods described herein may generate a distinct data summary based on each plot (using, for example, different summary prompts for the different types of plots). These data summaries may be used separately or compiled into a total plot summary for multiple plots relevant to analysis data 204 for use in future processing.

In general, markdown tables can include text formatted to convey analytical data (e.g., the data represented by or used to construct a plot) in a multi-column table to a generative model in a manner that helps the generative model (e.g., the attention mechanism of the generative model) recognize the relationships between the rows, columns, and values of the table, thereby improving the accuracy and relevance of responses provided by the generative model. In some examples, markdown tables can be carefully tailored according to specific rules for formatting, character spacing, overall volume of content, and/or specificity of data content (e.g., a number of decimal places for numeric data) to reduce the chances of hallucination in the generative model. As a specific example, a markdown table can include border markings to indicate the boundaries of the table to the generative model. As an additional example, a markdown table can include section dividers to represent different columns of data to the generative model. As a further example, all numeric data can be truncated to three significant figures. Markdown tables can also follow specific rules for character counts and spacing to ensure that generative models (e.g., LLMs) that receive the markdown table as an input form useful associations between the elements of data included in the markdown table.

The data summary or summaries (illustrated as data summary 218) can be used in conjunction with data dictionary 212 and context data 210 along with a relationship prompt template to construct a relationship prompt 220. Relationship prompt 220 can be submitted to generative model 222 to prompt the generative model 222 to generate relationship descriptions 224. A relationship description 224 can include a summarization of the contents of the plot data (e.g., in short prose or natural language). As a specific example, a relationship description for a data set may include descriptions of the most important feature or features for predicting a target variable along with a normalized importance of each feature and/or a directionality of the correlation between the feature and the target variable. In some examples, the relationship descriptions can also include explanations of which plot(s) the descriptions are derived from.

Relationship descriptions 224 can be used in conjunction with context data 210 along with an explanation prompt template to construct an explanation prompt, which can be provided to a generative model 228 to prompt the generative model to generate one or more potential explanations 230. A potential explanation 230 can include a possible explanation (e.g., a hypothesis) for why a certain relationship exists in a data set. For example, a potential explanation for a relationship observed in the patient readmission data set may include “patients with more inpatient visits prior to their current admission may have a higher risk of readmission due to a more complex medical history.” In this example, “patients with more inpatient visits have a higher risk of readmission” is the relationship between the variable of number of inpatient visits as it impacts the risk of later readmission, and “due to more complex medical history” is the explanation for why the aforementioned relationship exists.

Some examples of the systems and methods described herein may iteratively generate potential explanations 230 to ensure that generated explanations remain consistent with each other and are not unnecessarily repeated. Explanation prompt 226 can be constructed with an indication of a particular relationship description and can prompt generative model 228 to provide a completion that includes a potential explanation for the relationship. This completion can be appended to the original prompt, thus constructing a new iteration of the prompt that can then be provided to generative model 228 to generate a second potential explanation from the relationship. This process can be repeated until the desired number of explanations for the selected relationship have been generated.

In some embodiments, each relationship description in relationship descriptions 224 can be processed using explanation prompt 226 individually. That is, in these embodiments, explanation prompt 226 includes an indication of the selected relationship. In other embodiments, the iterative process described above can, once the desired number of explanations for the first relationship have been generated, add an indication of the next relationship in relationship descriptions 224 and generate a desired number of explanations for the newly added relationship, with the original prompt and completions related to the first selected relationship serving as context for generating explanations for the next selected relationship. This process can be repeated until potential explanations have been generated for each of relationship descriptions 224, or until potential explanations for a selected subset of relationship descriptions 224 have been generated. In some embodiments, any or all of generative models 208, 242, 222, and 228 can be the same model. In other embodiments, any or all of generative models 208, 242, 222, and 228 can be different models. For example, generative model 208 may be a less sophisticated and/or less resource-intensive model that allows savings in terms of computational power, model usage costs, or other factors since generating data dictionary 212 may involve a lower level of model complexity than generating relationship descriptions 224.

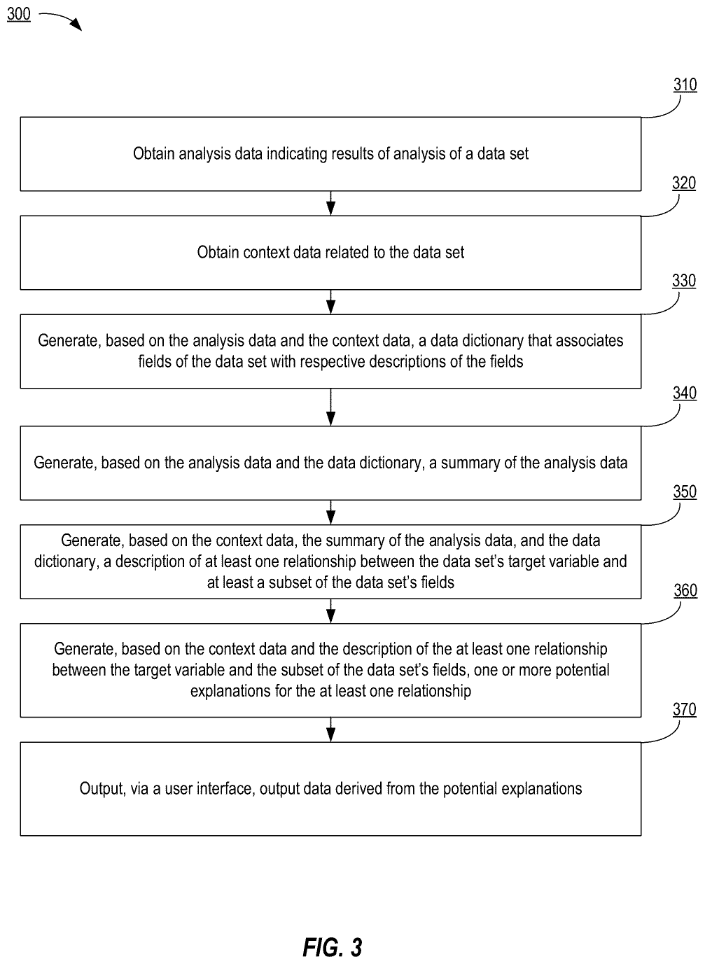

FIG. 3 is a flow diagram illustrating an example method 300 for generating descriptions of data sets and/or models. At step 310 of FIG. 3, a system can obtain analysis data indicating results of analysis of a data set. The data set may include a set of records. Each record in the set of records may include values of one or more respective features (e.g., fields) as well as a value of an outcome variable. For example, system 100 from FIG. 1 can obtain analysis data 204, which indicates results of analysis of records 202.

System 100 can obtain the analysis data using any suitable technique. In some examples, system 100 may automatically retrieve project data from a repository, database, or similar. For example, system 100 may be aware of what data analysis projects a particular user has access to and may automatically pull analysis data for that user's projects. In other examples, a user may manually direct system 100 to retrieve a particular set of analysis data.

Returning to FIG. 3 at step 320, the system can obtain context data related to the data set. In some embodiment, the context data includes a characterization of a use case of the data set. For example, system 100 can obtain context data 210. In some embodiments, the context data can include a short description of an intended use case of the data set, such as “This data set can be used to predict 30-day patient readmission rates.” This context data can be user-provided or automatically generated by, for example, a generative model based on information or metadata related to the analysis project and/or received as a manual user input.

At step 330 of FIG. 3, the system can generate, based on the analysis data and the context data, a data dictionary that associates fields of the data set with respective descriptions of the fields. For example, data dictionary processor 112 of system 100 can construct a dictionary prompt 206 based on analysis data 204 and context data 210, and that prompt can be provided to generative model 208 to prompt the generative model to generate data dictionary 212. Some examples of techniques for generating a data dictionary are described in further detail below.

At step 340, the system may generate, based on the analysis data and the data dictionary, a summary of the analysis data. For example, system 100 may construct a summary prompt 240 based on analysis data 204 and data dictionary 212, and that prompt may be provided to generative model 242 to prompt the generative model to generate data summary 218 of a data set. In some examples, data summary 218 may include a concise recap of the most important aspects of analysis data 204 as indicated by feature impact data. In some embodiments, data summary 218 may include a short paragraph (e.g., one sentence per feature of interest) of natural language text summarizing a plot. Some examples of techniques for generating a summary of analysis data are described in further detail below.

At step 350, the system may generate, based on the context data, the summary of the analysis data, and the data dictionary, a description of at least one relationship between the target variable and at least a subset of the data set's fields. For example, system 100 may construct one or more relationship prompts 220, and those prompts may be provided to generative model 222 to prompt the generative model to generate one or more relationship descriptions 224. In general, a relationship description (which can also be referred to as an observation or insight) may be a factual statement about a particular trend in a data set, about a particular correlation between two variables, about correlations between multiple features or independent variables and their corresponding effects on the target variable, and/or about any other aspect of the data set. Some examples of techniques for generating relationship descriptions of analysis data are described in further detail below.

At step 360, the system may generate, based on the context data and the relationship description(s), one or more potential explanations for the described relationship(s). For example, system 100 may use context data 210 and relationship description(s) 224 to construct one or more explanation prompts 226, and those prompts may be provided to generative model 228 to prompt the generative model to generate one or more potential explanations 230. Potential explanations 230 may include explanations for each of the relationships described in the relationship descriptions 224, and these explanations may each be associated with the relevant relationship to produce meaningful statements that can be easily understood by an end user. Some examples of techniques for generating potential explanations of relationships in a data set are described in further detail below.

At step 370, the system may output, via a user interface, output data derived from one or more of the potential explanations 230. For example, system 100 in FIG. 1 may output an identified relationship and an associated explanation via user interface 142 of client device 140. The system may provide this output in a variety of ways in response to a variety of user inputs. In some embodiments, the user input may originate from a user selecting an “assist” button in the user interface, typing a text command into the user interface, or otherwise requesting assistance via the user interface. The output may likewise be provided in a variety of ways and/or formats depending on the input received from the user. For example, the user input may indicate that the user wishes to engage in a question and answer (“Q&A”) style examination of the data. As an additional example, the user input may prompt the system to generate an executive summary of the analysis data.

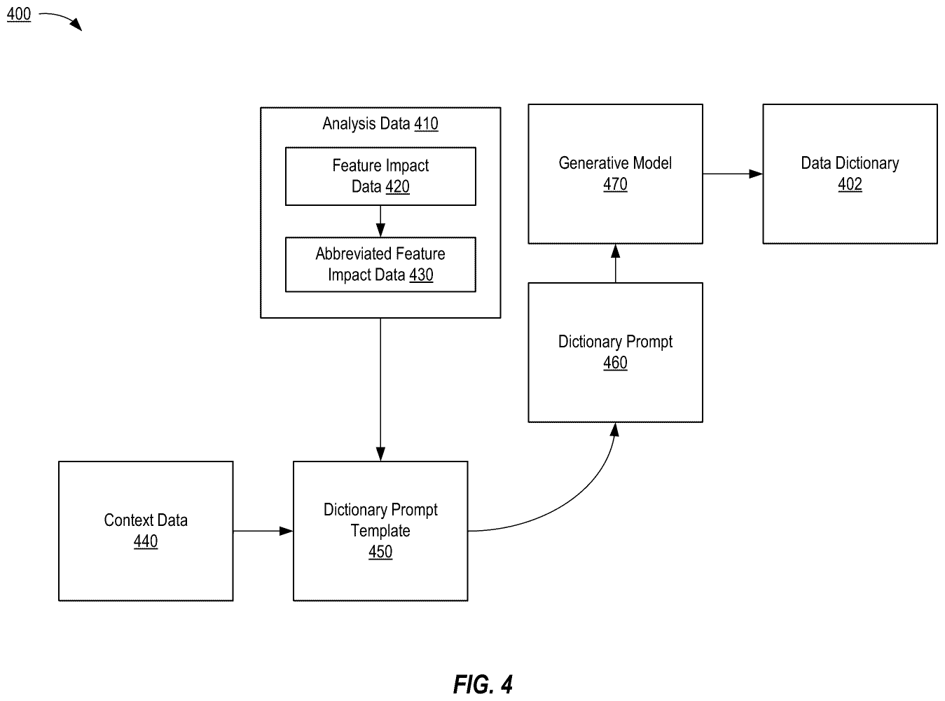

As described above, the method 300 can include a step 330 of generating a data dictionary. FIG. 4 is a block diagram of an example method 400 for generating a data dictionary. As shown in FIG. 4, analysis data 410 can include feature impact data 420, which can in turn be summarized as abbreviated feature impact data 430.

Abbreviated feature impact data 430 can be generated in a variety of ways. In some embodiments, the systems and methods described herein may simply select a certain number of features determined, as indicated in analysis data 410, to be the most strongly correlated with the outcome or target variable. As a specific example, a data analyst may configure system 100 to select the five, six, seven, eight, nine, or ten most important features from analysis data 410 to create abbreviated feature impact data 430. Abbreviated feature impact data 430 can include each of the selected features along with statistical information about each selected feature. In some embodiments, the statistical information may be derived from exploratory data analysis (EDA) data for each of the selected features. In one example, a feature included in abbreviated feature impact data 430 can include the field name, the field type (e.g., numeric), a median value, a standard deviation, and one or more frequent values associated with the field. This information can be inserted into a dictionary prompt template 450 along with context data 440 to create dictionary prompt 460. Dictionary prompt 460 can then be submitted to generative model 470 to yield data dictionary 402, which associates each selected feature with a short explanation of what the field contains. Generating abbreviated feature data in this way is particularly important because providing a full enumeration of all the fields in a data set may overwhelm a generative model and/or induce hallucinations, thus reducing the quality of any insights or explanations generated in later steps. Additionally, abbreviating the data by only selecting features of at least a threshold importance or from a certain number of most impactful features reduces processing time by eliminating downstream processing of data related to features that do not strongly contribute to changes in the target variable and thus do not offer meaningful insights into the original data analysis. In other words, features are pruned from consideration if they are less or not important to the final outcome of the analysis.

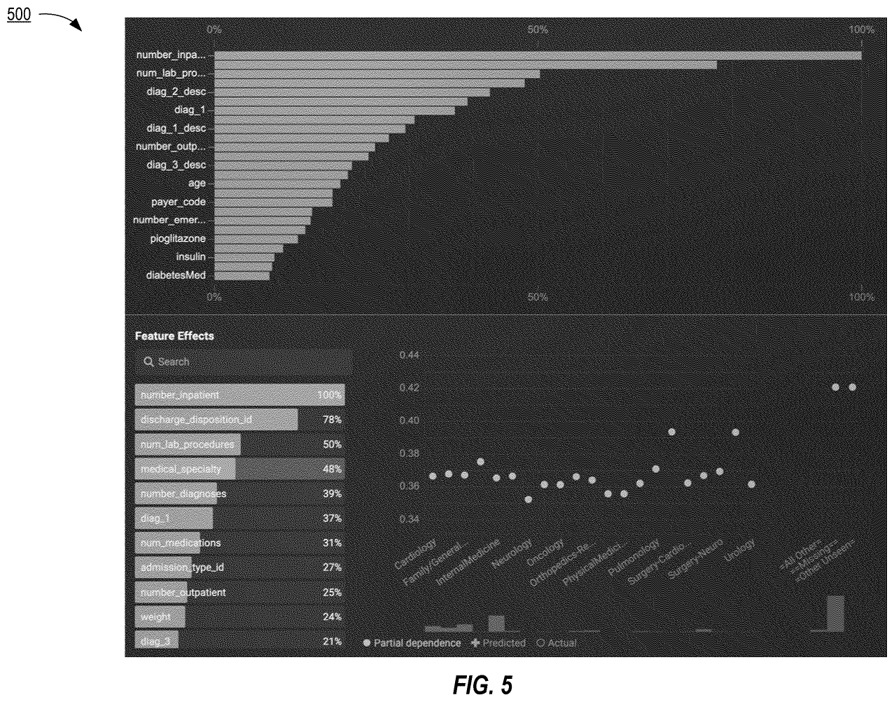

FIG. 5 is an illustration of an example user interface 500 displaying a visualization of an example feature impact plot. As shown in the upper portion of the illustration, the plot may include a listing of several features derived from analysis data as labels for a bar graph or histogram indicating a relative impact that each feature has on the target variable. In this example, the field “number_inpatient” (abbreviated as “number_inpa . . . ” in the upper bar graph) has a normalized importance of 100%, indicating that changes in this field have the greatest impact on the target variable of likelihood of patient readmission. Other variables have decreasing importance, normalized to the impact of the most impactful variable. Other visualizations of this data are also included. The lower left region of the illustration shows the same enumeration of features along with the actual numeric value of the normalized impact. The lower right region shows possible values for the field selected in the lower left region (in this case, “medical_specialty”) along with an approximation of how each value affects the target variable. In this case, patients admitted under certain medical specialties are more likely to be readmitted to the hospital than others. As described with respect to FIGS. 2 and 4, this feature impact data can be abbreviated and/or specific features or fields can be selected based on the feature impact data with which to create a data dictionary and/or to be used in downstream processes for generating natural language summaries of the overall data analysis.

Returning to FIG. 4, the systems and methods described herein may iteratively generate data dictionary 402. In these examples, a system can create a first prompt using a dictionary creation prompt template and inserting context data 440 along with a line for one field from abbreviated feature impact data 430 and any relevant statistical data. This prompt can then be submitted to generative model 470 to produce a dictionary entry for the field. The systems and methods described herein can append the response from generative model 470 to the previously submitted prompt along with a new line for a second field from abbreviated feature impact data 430 to iteratively create a new prompt and submit this new prompt to generative model 470. This process can be repeated until all fields from abbreviated feature impact data 430 have been progressively submitted to generative model 470. The collated enumeration of fields and associated responses from generative model 470 can then be used to create data dictionary 402.

As described above, data dictionaries can include a listing of fields from analysis data along with descriptions of the fields derived from a generative model. For example, an entry in a data dictionary can read “‘annual_inc’: This field contains the annual income of the consumer.” These entries can be represented in a variety of ways, including but not limited to a text file, a JSON file, or any other mode of storing dictionary data.

One specific example of a dictionary prompt for generating a data dictionary based on a quantitative analysis looking to predict whether or not a consumer loan will be repaid is provided in Example 1:

### Example 1

Consumer credit scoring. We are predicting whether or not a consumer loan will be paid back.
I am using a dataset for this work; it is possible that a data scientist has already done some, common, simple transformations on the original raw data to prepare it for modeling.
For select fields, below I have listed the field name, the data type of the field (if known), frequent values or summary statistics, and most importantly, a brief description of what the field contains:
annual_inc (Numeric; median of 58000, standard deviation of 49000; frequent values: ‘49794.66666666667’, ‘39998.66666666667’):

In this example, the first two sentences represent context data as described above (e.g., context data 210). This context data may change from project to project, though according to this specific prompt template, the context data will always be provided at the beginning of the prompt. The next block of text provides prompt context to the generative model briefly explaining the nature of the input data that will be provided later in the prompt. These text blocks remains consistent from project to project as part of the prompt template designed to cause generative models to produce relevant responses that can be used to construct a data dictionary. The last block of text includes the field name of the first feature selected for inclusion in the data dictionary along with statistical analysis data as described above followed by a “:” to indicate to the generative model that the line is incomplete, thereby causing the model to complete the line with text such as the following:

This field contains the annual income of the user.

This completion can be appended to the prompt outlined above to complete the entry for “annual_inc”, a block of text including the field name of the next feature selected for inclusion in the data dictionary and its associated statistical analysis data, concluding in another “:” as above. This process can be repeated for each selected feature until all selected features have been described by the generative model. The feature field names and generative model completions can then be compiled into a more accessible format (e.g., JSON, as described above) for use as a data dictionary in later steps of the processes described herein.

As described above, the method 300 can include a step 340 of generating a summary 218 of the analysis data. In some examples, data summary 218 may include a concise recap of the most important aspects of analysis data 204 as determined by feature impact data, such as abbreviated feature impact data 430. In some embodiments, data summary 218 may include a short paragraph (e.g., one sentence per involved feature) of natural language text summarizing a plot. In the case of a summary of a feature impact plot such as the plot shown in FIG. 5, this summary can include a factual recitation of the most important features of the plot along with normalized importance values. In the case of a summary of a partial dependence plot, the corresponding summary can include a factual recitation of the most important features in the analysis data along with a directionality and magnitude of the impact of the feature on the target variable. In the case of a summary of a word cloud plot, the corresponding summary can include word frequencies as well as how strongly the presence of each word is connected to the target variable. Other plot types may have correspondingly different summaries.

The systems and methods described herein may generate a variety of data summaries as part of generating data summary 218. In some examples, a system may generate a data summary of each plot derived from analysis data 204, or in other examples only generate summaries of a subset of the plots. In some embodiments, a system can compile multiple individual plot summaries into an overall data summary of analysis data 204, which includes summaries of each selected plot or subset of plots. The system may additionally use different prompt templates for each plot type. That is, a prompt template for generating a summary of a feature impact plot may be different than a prompt template for generating a summary of a partial dependence plot.

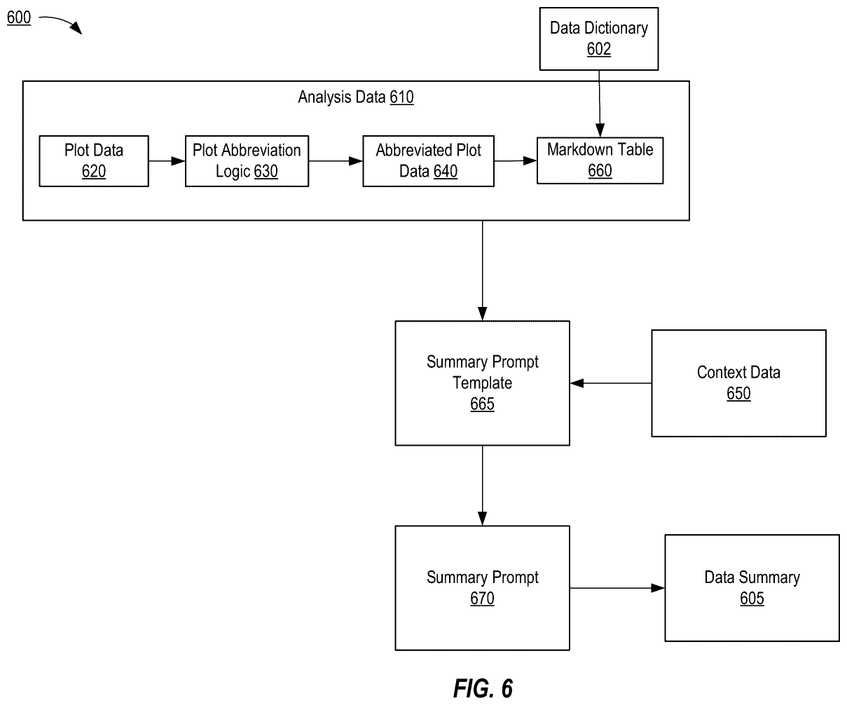

FIG. 6 is a block diagram of an example method 600 for generating a data summary. As shown in FIG. 6, Analysis data 610 can be combined with information from data dictionary 602 and context data 650 to create summary prompt 670. In some embodiments, analysis data 610 may include plot data 620, abbreviated plot data 640, and/or markdown table 660, which all represent different forms and different stages of processing the original data from the analytical project (e.g., records 202 as illustrated in FIG. 2). In the example shown in FIG. 6, plot data 620 can be processed using plot abbreviation logic 630 to produce abbreviated plot data 640. In some cases, plot abbreviation logic 630 can use abbreviations of one plot to inform the abbreviations of another plot. For example, plot abbreviation logic 630 could use abbreviated feature impact data 430, which relates to a feature impact plot, to inform abbreviation of a partial dependence plot by ensuring that the same features are selected for both plots.

Abbreviated plot data 640 can be combined with information from data dictionary 602 to create markdown table 660. As described above, a markdown table can be a text representation of tabular data, formatted to reduce the likelihood that a generative model such as an LLM produces hallucinations or other errors. In the examples described herein, markdown tables are generated based on abbreviated plot data for conciseness and to limit the amount of information provided to the generative model. Creating markdown tables based on abbreviated plot data may reduce the likelihood of hallucinations when provided to generative models versus markdown tables that include all features represented in plot data. Markdown table 660 can be combined with context data 650 using summary prompt template 665 to create summary prompt 670. Summary prompt 670 can in turn be submitted to a generative model (such as generative model 242 in FIG. 2) to produce data summary 605. This process can be repeated for each plot relevant to analysis data 610, and the summaries of each individual plot can be combined into a full data summary of analysis data 610. In the example of FIG. 2, data summary 218 can be such a full data summary.

Continuing with the above-described example of consumer loan repayment, an example of a summary prompt created using a summary prompt template is provided in Example 2:

### Example 2

Consumer credit scoring. We are predicting whether or not a consumer loan will be paid back.
Permutation-based feature importance has been calculated for the best performing predictive model and recorded for the top features in the table below:

| Feature Description | imp | ID |
|---|---|---|
| This field contains | 1 | total_rec_int |
| the total amount of | | |
| interest paid by the | | |
| consumer. | | |
| This field contains | 0.58 | term |
| the length of the | | |
| loan in months. | | |
| This field contains | 0.49 | total_rec_late_fee |
| the total amount of | | |
| late fees that the | | |
| consumer has paid on | | |
| the loan. | | |
| This field contains | 0.41 | int_rate |
| the interest rate of | | |
| the loan. | | |
| This field contains | 0.39 | annual_inc |
| the annual income of | | |
| the consumer. | | |

We now summarize the table in a few sentences, including descriptions for the features (noting their corresponding database id), and also recapping specific importance values.

In the example of the prompt shown in Example 2, the prompt starts with context data at the top to provide the generative model with context surrounding the intended use case of the analysis data and to guide the generative model into producing insights relevant to the provided context data. Next, a block of static text (e.g., consistent across all uses of the prompt template) is included to signal to the generative model that the following text represents a table containing information relevant to the analysis. After the static text, the prompt includes a markdown table constructed from information included in the data dictionary and the abbreviated plot data. In the example of this particular markdown table, entries for each of the five selected features are included, linking each feature's field name (the column labeled “ID”) with an associated natural-language description from the data dictionary (the column labeled “Feature Description”) as well as the normalized importance of the field (the column labeled “imp”). As described above, the markdown table also includes border markings constructed from “−”, “|’, and “+” characters to indicate the borders and column delineations of the table and is constructed according to a predetermined format that includes column character widths, spacings, etc. configured to the specific generative model being used to reduce the likelihood that the model generates a hallucination. Although a markdown table is one particular way of conveying this information in a linked manner comprehensible to a generative model, other information structures could be used, such as the line-by-line enumeration used in the generation of data dictionaries as described above. The prompt concludes with static text that guides the generative model into creating a data summary.

Continuing with the above-described example of consumer loan repayment, an example of a data summary is provided below in Example 3:

### Example 3

The most important feature for predicting consumer loan repayment is total_rec_int, which is the total amount of interest paid by the consumer. This feature has a normalized importance of 1. The second most important feature is term, which is the length of the loan in months, with a normalized importance of 0.58. The third most important feature is total_rec_late_fee, which is the total amount of late fees that the consumer has paid on the loan, with a normalized importance of 0.49. The fourth most important feature is int_rate, which is the interest rate of the loan, with a normalized importance of 0.41. The fifth most important feature is annual_inc, which is the annual income of the consumer, with a normalized importance of 0.39.

As shown in the example of Example 3, the data summary includes a prose recitation of the top selected features in the analysis data, connecting the field label or name with a natural-language explanation of what the field represents along with the relative importance of each feature, normalized to the most important feature. In this example, five features were selected for inclusion in the data summary, and this summary enumerates each feature along with the relative importance of each feature on the target variable (in this case, consumer loan repayment).

Another example of a summary prompt, constructed to prompt a generative model to provide a summary of a word cloud, is provided below in Example 4:

### Example 4

Consumer credit scoring. We are predicting whether or not a consumer loan will be paid back.
A word cloud was generated for all text features. The coefficients for each word in the word cloud represent the average impact the presence of this word has on the target consumer loan repayment in a simple linear model. The text features have the following definitions:
total_rec_int: the total amount of interest paid by the consumer
term: the length of the loan in months
total_rec_late_fee: the total amount of late fees that the consumer has paid on the loan
int_rate: the interest rate of the loan
annual_inc: the annual income of the consumer
The word cloud coefficients are summarized in the table below:

| Word | Coefficient |
|---|---|
| type | 1 |
| acute | 0.95 |
| failure | 0.87 |
| coronary | 0.85 |
| graft | 0.72 |

We now summarize implications and observations from the data in a few sentences, including qualitative observations on how the presence of particular words impacts the relative likelihood of consumer loan repayment.

In Example 4, the prompt starts with context data at the top to provide the generative model with context surrounding the intended use case of the analysis data and to guide the generative model into producing insights relevant to the provided context data. Next, a block of static text (e.g., consistent across all uses of the prompt template) that incorporates the indicated outcome variable provides a brief overview of the additional data included in the prompt, in this case field definitions as recorded in the data dictionary for the text fields used to generate the word cloud plot. Next, a block of static text introduces a markdown table including data for words in the word cloud plot. The markdown table may be based abbreviated word cloud data (e.g., the top 5, 10, 15, or other appropriate number of words with the strongest coefficient). The markdown table in this example shows coefficient data for five selected words from the word cloud plot data, linking a specific word (the column labeled “Word”) with its associated word cloud coefficient (the column labeled “Coefficient”). As described above, the markdown table also includes border markings constructed from “−”, “|’, and “+” characters to indicate the borders and column delineations of the table and is constructed according to a predetermined format that includes column character widths, spacings, etc. configured to the specific generative model being used to reduce the likelihood that the model generates a hallucination. After the markdown table, the prompt includes additional static text constructed to guide the generative model into providing an appropriate data summary of the word cloud plot data.

An additional example of a summary prompt, constructed to prompt a generative model to provide a summary of a partial dependence plot, is provided below in Example 5:

### Example 5

Consumer credit scoring. We are predicting whether or not a consumer loan will be paid back.
A partial dependence plot of the target consumer loan repayment on the independent variable [feature] was calculated.

| | |
|---|---|
| Value | PD Impact |

We have consulted with experts in this field to identify a list of the most plausible hypotheses that explain these trends and observations:

Much as with the other examples provided above, the example summary prompt for prompting a generative model to summarize partial dependence plot data starts with the context data at the top to provide the generative model with context surrounding the intended use case of the analysis data and to guide the generative model into producing insights relevant to the provided context data. Next, a brief portion of static text modified to mention a specific feature from the partial dependence data introduces the partial dependence data. The partial dependence data (or in this example, abbreviated partial dependence data) is represented in the form of a markdown table. Although the markdown table illustrated here is empty, an actual completed prompt for summarizing partial dependence data would include partial dependence data in the markdown table. In this example, the markdown table includes a column for a given value of the feature for which the partial dependence plot was generated (the column labeled “Value”) as well as a column for the impact that the indicated value has on the outcome variable (the column labeled “PD Impact”. As with the other prompts for generating data summaries, the markdown table for the partial dependence data may only include the most impactful values for the indicated feature to reduce the chance of hallucination in the generative model. As described above, the markdown table also includes border markings constructed from “−”, “|’, and “+” characters to indicate the borders and column delineations of the table and is constructed according to a predetermined format that includes column character widths, spacings, etc. configured to the specific generative model being used to reduce the likelihood that the model generates a hallucination. The markdown table shown in Example 5 is only one possible example of a markdown table for including partial dependence data in a prompt for a generative model; other forms, structures, and types of markdown table can be used. The prompt concludes with static text that guides the generative model into creating a data summary for the partial dependence plot.

As described above, the method 300 can include a step 350 of generating a description of a relationship between the target variable and at least a subset of the fields of a data set. As with steps 330, 340, and 360 of method 300, the system can construct a suitable prompt for a generative model by collecting the relevant information into a corresponding prompt template. For example, context data 210, data summary 218, and relevant entries from data dictionary 212 can be inserted into a relationship synthesis prompt, which can in turn be provided to a generative model such as generative model 222 to produce relationship descriptions 224.

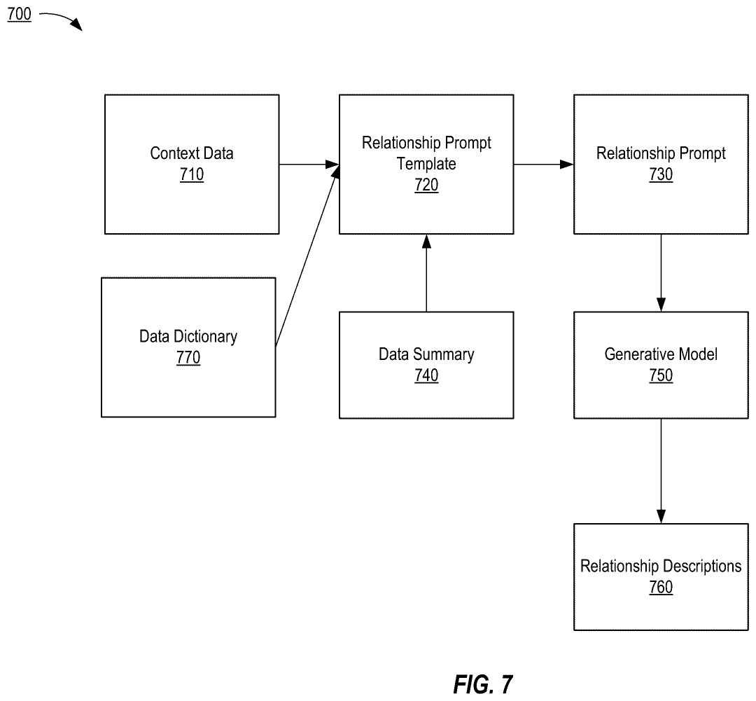

FIG. 7 is a block diagram of an example method 700 for generating relationship descriptions. As shown in FIG. 7, context data 710 and data summary 740 can be combined with information from data dictionary 770 (e.g., dictionary entries related to the fields included in data summary 740) and applied to relationship prompt template 720 to create relationship prompt 730. Relationship prompt 730 can be provided to generative model 750, which may be a language model or other generative model. Generative model 750 can return relationship descriptions 760.

In some examples, relationship descriptions can be generated iteratively. For example, a system can iterate through each field included in data summary 740, applying each field name individually to relationship prompt template 720 to produce an insight for that field. The system can then iterate to the next field indicated by data summary 740, generating an insight or observation for that field, repeating the process until an insight has been generated for each field included in data summary 740.

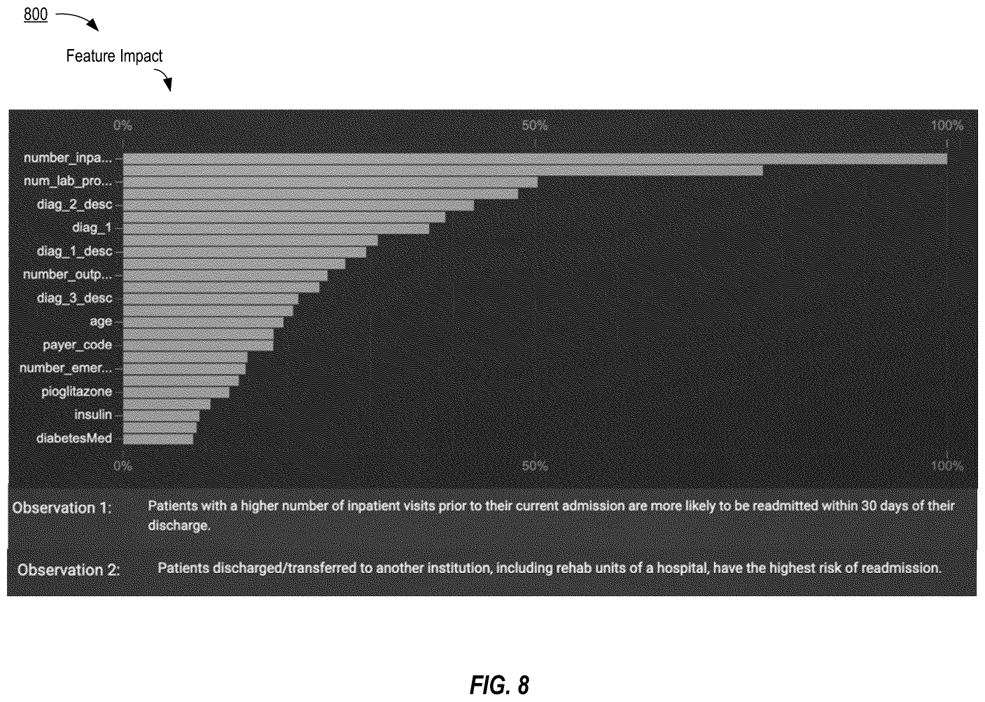

FIG. 8 is an illustration of an example user interface 800 displaying feature impact data along with relationship descriptions pertaining to the original analysis data from which the feature impact data was derived. As illustrated in FIG. 8, the two example observations are factual statements about relevant features and how they affect the patient readmission rate. In this example, the relationship descriptions are natural language text strings generated by a language model, though other forms of generative model could be used. Observation 1 discusses the relationship of number of inpatient visits on readmission rates, and more specifically that “patients with a higher number of inpatient visits prior to their current admission are more likely to be readmitted within 30 days of their discharge.” Observation 2 focuses on the readmission rates for patients who were discharged or transferred to another institution. Both of these insights were generated by a generative model in response to receiving a relationship prompt.

As described above, the method 300 can include a step 360 of generating one or more potential explanations for the relationship(s) described by the relationship descriptions 224.

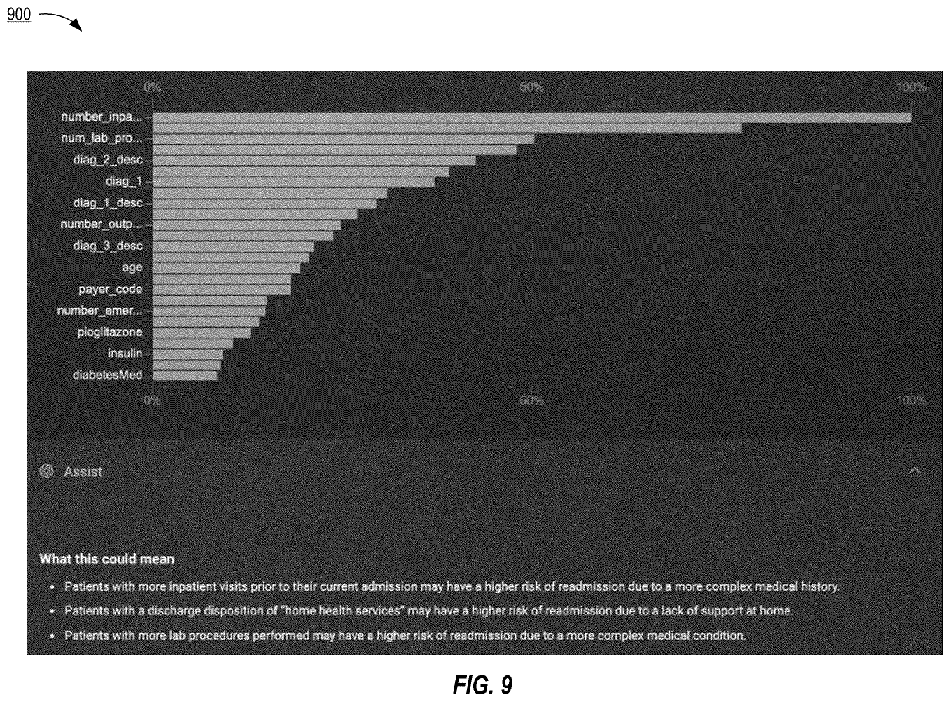

FIG. 9 is an illustration of a portion of an example user interface that is displaying a collection of potential explanations for trends observed in the analysis data. In this example, each explanation follows a statement-due-to-explanation format, though other formats could be generated by a generative model depending on the exact prompt and model used.

FIG. 9 is an illustration of an example user interface 900 displaying three potential explanations for trends observed in patient readmission data. Each of these explanations connects a relationship identified earlier to a possible explanation. For example, the first explanation indicates that more inpatient visits prior to the current visit results in a higher readmission rate because of a more complex medical history. In this case, the link between inpatient visits and readmission rate is the relationship, insight, observation, and trend, and more complex medical history is the possible explanation for why this relationship between the field and the target variable might exist. While these explanations may be speculative on the part of the generative model, they are typically created in view of large amounts of training data that allows the generative model to suggest reasons based on rationales seen in other data analyses and other contexts. The upper portion of example user interface 900 is a representation of feature impact data from the data analysis to give visual context for the explanations provided.

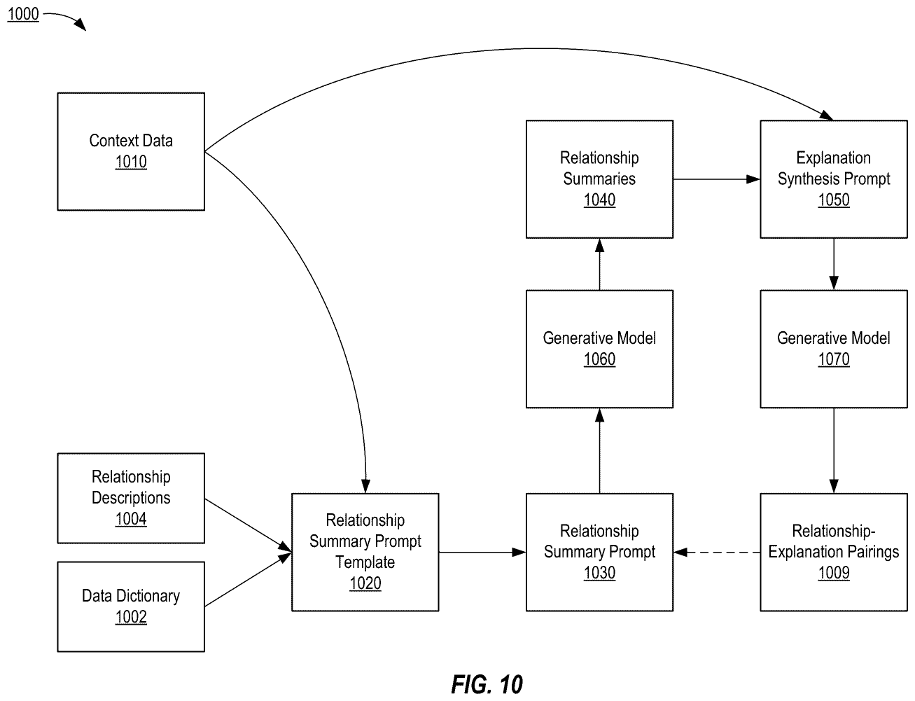

FIG. 10 is a block diagram of an example method 1000 for creating relationship-explanation pairings as described above. In some examples, the method 1000 may be performed to generate an executive summary of one or more potential explanations for one or more relationships observed between variables in a data set. In the example of method 1000 and as mentioned above, context data 1010, relationship descriptions 1004, and portions of data dictionary 1002 can be programmatically combined using a relationship summary prompt template 1020 to generate relationship summary prompt 1030. Relationship summary prompt 1030 can then be provided to generative model 1060 to generate relationship summaries 1040. The systems and methods described herein can then iterate across the relationship summaries 1040 using explanation synthesis prompt 1050 and context data 1010, submitting the prompts to one or more generative models, including generative model 1070, either sequentially or in parallel to produce relationship-explanation pairings 1009. This iterative process can ensure that every selected relationship identified in relationship summaries 1040 is associated with relevant explanations, and further to ensure that the generative model generates explanations that are consistent with each other as well as unique to each relevant explanation. Although generative models 1060 and 1070 are illustrated as separate components in the context of FIG. 10 and indeed may represent two different generative models, generative models 1060 and 1070 as illustrated may represent the same generative model, such as generative model 228 in FIG. 2.

In some embodiments, generated relationship-explanation pairings for a particular relationship or insight can be appended to a previous prompt to generate a new prompt that can be provided to a generative model to create a prompt that causes the generative model to produce new explanations for the relationship being examined. This iterative generation of explanations for each relationship can ensure that a collection of non-overlapping and internally consistent explanations are generated for the data relationship.

An example of an explanation prompt tailored to cause a generative model to produce explanations for trends and features observed in a data set is provided below in Example 6. This particular prompt is tailored to cause a generative model to generate explanations for feature impact plot information as detailed in the feature impact plot summary described above. Other templates may be used for generating explanations for trends observed in other types of plots, such as partial dependence plots.

### Example 6

Consumer credit scoring. We are predicting whether or not a consumer loan will be paid back.
Permutation-based feature importance was calculated for the best-performing model. The most important feature for predicting consumer loan repayment is total_rec_int, which is the total amount of interest paid by the consumer. This feature has a normalized importance of 1. The second most important feature is term, which is the length of the loan in months, with a normalized importance of 0.58. The third most important feature is total_rec_late_fee, which is the total amount of late fees that the consumer has paid on the loan, with a normalized importance of 0.49. The fourth most important feature is int_rate, which is the interest rate of the loan, with a normalized importance of 0.41. The fifth most important feature is annual_inc, which is the annual income of the consumer, with a normalized importance of 0.39.
We have consulted with experts in this field to identify the most plausible hypotheses that explain the presence of the aforementioned strong relationships, but intentionally not speculating on the direction of impact:
1.

In this example prompt and as with other example prompts described herein, the prompt starts with context data detailing a use case and broad context for the prompt. Next, the prompt includes a section for text describing the top selected features (in this case, four features) with the highest normalized importance in prose form to ensure that the details included are properly considered by the generative model. In this case, the prose format includes a recitation of the field label, the natural-language description as included in the data dictionary, and a statement of the normalized importance of the feature (e.g., information derived from the feature impact plot and associated plot summary). The final block of text is static text that prompts the generative model to generate a completion related to explaining the presence of the indicated relationships. Finally, the “1.” at the end aids in iterative formatting of the prompt to create a series of explanations related to the prompt. The first completion may be appended immediately after the “1.” and a new line with “2.” may be appended to the prompt. This revised and expanded prompt may iteratively be provided to the generative model until a desired number of explanations have been generated. Iteratively generating explanations in this manner may prevent the generative model from generating duplicate explanations (and thus wasting time or computing resources) while also ensuring that the model generates explanations that are consistent with both the data set and with each other.

An example completion for the example prompt shown above can consist of the following, which can then be used as a relationship/explanation pairing.
Consumers with higher incomes are more likely to pay back their loans because they have more financial resources.

As described above, the method 300 can include a step 370 of outputting data derived from the processing performed in the preceding steps of the method 300.

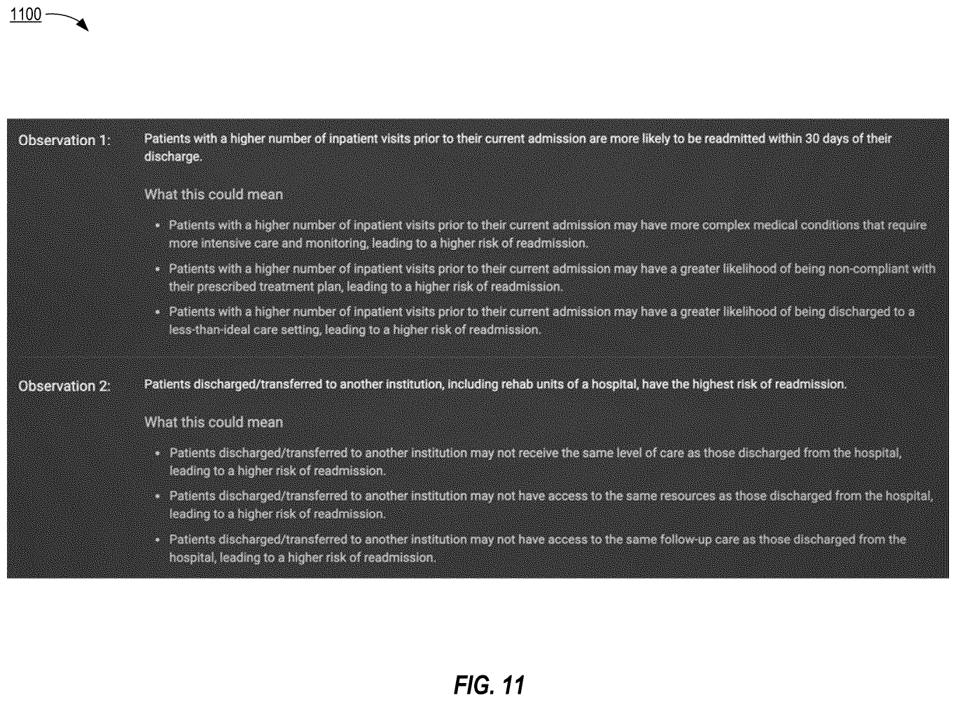

FIG. 11 is an illustration of an example output of the aforementioned relationship-explanation generation process being displayed via a portion of an example user interface 1100. As shown in FIG. 11, an explanation synthesis system such as system 100 in FIG. 1 has identified two data relationships, labeled Observation 1 and Observation 2, in the original analysis data and generated three explanations or hypotheses for each observation. These explanations provide possible reasons for why the observed features or fields in the original analysis contribute to the target variable or outcomes in the ways that they do.

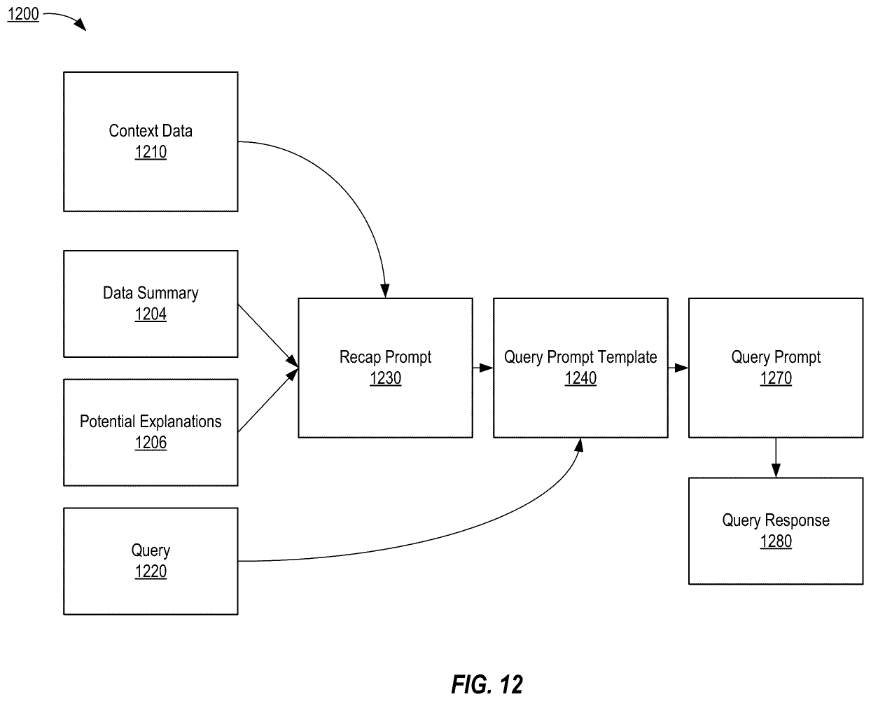

In some embodiments, the relationship-explanation pairings described above can be used to power a question-and-answer interactive process that allows users (such as data analysts or data scientists) to prompt the system with natural language queries about a data set to receive useful insights. FIG. 12 is a block diagram of an example method 1200 for powering such a chat experience. In this example, context data 1210 can be combined with data summary 1204 and potential explanations 1206 to create a recap prompt 1230 summarizing the analysis data, the data relationships observed, and the associated potential explanations for each data relationship. This recap prompt can then be combined with a user-provided query 1220 via query prompt template 1240 to create query prompt 1270. Query prompt 1270 may in turn be provided to a generative model to generate a query response 1280 that responds to query 1220. A user can then provide another query prompt to continue the interaction. In these situations, a prior transcript of one or more previous queries can be included in query prompt 1270, thereby providing additional context to the generative model to ensure that the model generates useful and self-consistent replies to the user's queries.

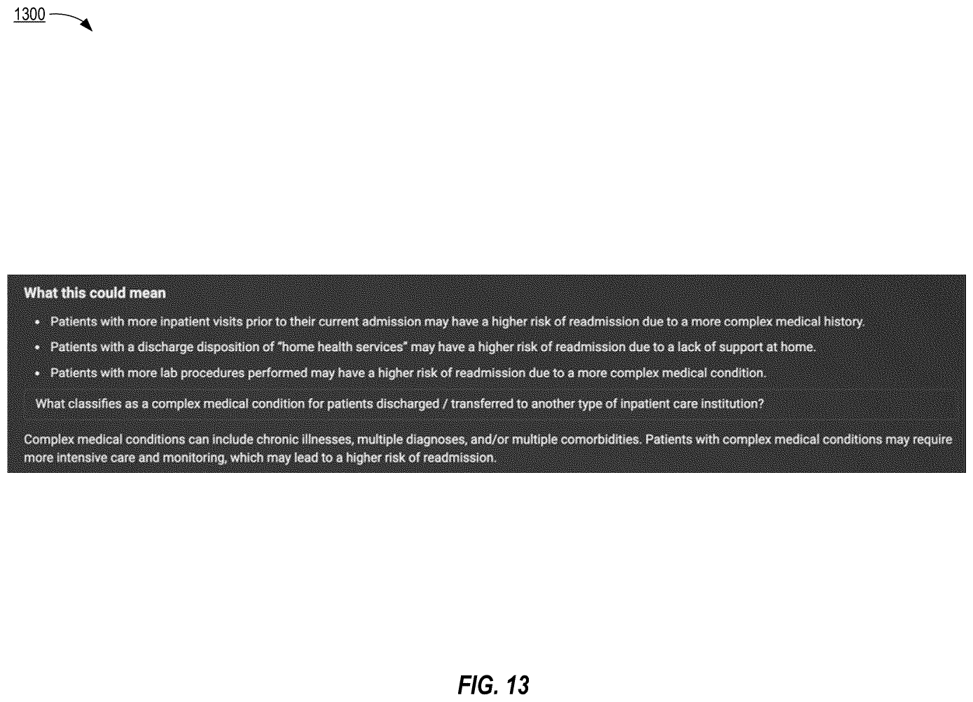

User-provided query 1220 may be received via a user interface, and query response 1280 may correspondingly be presented back to the user by the same interface. FIG. 13 is an illustration of an example user interface 1300 displaying one round of a query session between a user and the systems and methods described herein. The upper portion of user interface 1300 shows a number of relationship-explanation pairings derived as described above. Below these insights, user interface 1300 displays an input box into which a user has entered a follow-up question asking “what classifies as a complex medical condition for patients discharged/transferred to another type of inpatient question?” Questions or queries can be used to query the model to gain further insights as to how the model arrived at the relationship-explanation pairings, elaborate on technical information a user might not be familiar with, cause the model to generate additional insights, and so on to provide a natural chat-like experience for end users. Once the question has been submitted, the systems and methods described herein may, as described above, use the query to generate a prompt that can be fed into a generative model to produce an answer. In this case, the answer provides specific examples of complex medical conditions as understood by the generative model, and further explains why and how the presence of such conditions in patient's medical history might affect their readmission probability.

While the examples above have been directed to general quantitative analysis over a data set of many entries, rows, or examples, the systems and methods described herein can also be used to generate explanations for individual predictions, sometimes referred to as prediction explanations. These prediction explanations can help data scientists tune or train a predictive model, identify model errors, or confirm a model's predictions. These insights can also be used by data scientists and data analysts to gain insights into how a predictive model arrived at a specific prediction (e.g., whether a particular consumer is likely to repay their loan, or whether a particular patient is likely to be readmitted to the hospital), granting them a deeper understanding of the underlying data behind the prediction.

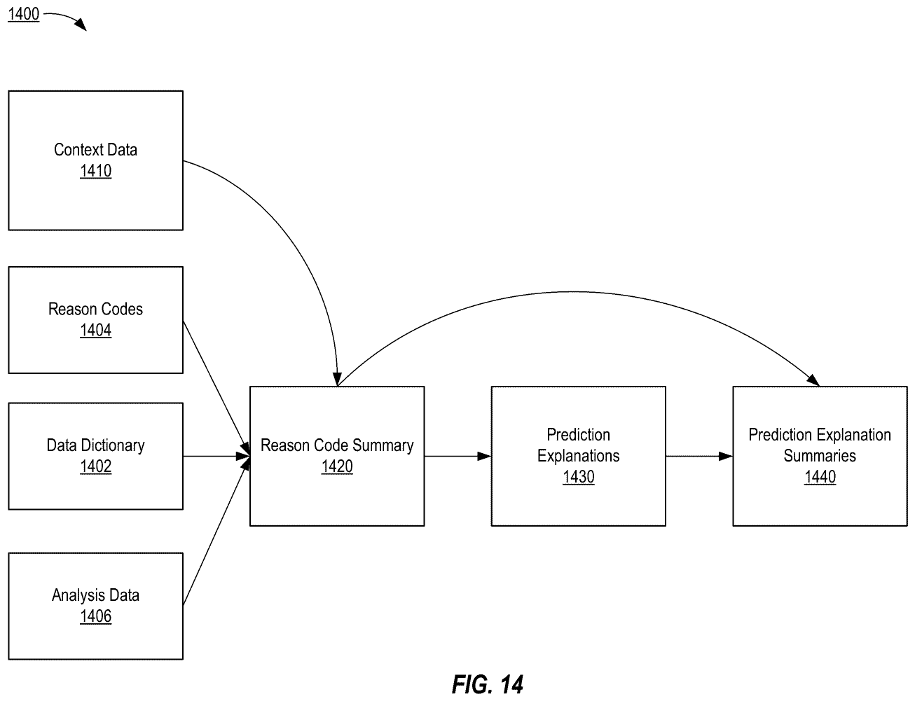

FIG. 14 is a block diagram of an example method for generating prediction explanation summaries. As shown in the example of FIG. 14, analysis data 1406, reason codes 1404, and context data 1410 can be combined with relevant information from data dictionary 1402 to generate reason code summary 1420, which can be generated programmatically or by providing the constituent information to a generative model via a summary prompt. Reason code summary 1420 can be provided to a generative model to create prediction explanations 1430. Prediction explanations 1430 and reason code summary 1420 can then be combined using a prompt template and provided to a generative model to create prediction explanation summaries, similar to the relationship-explanation pairings described above.

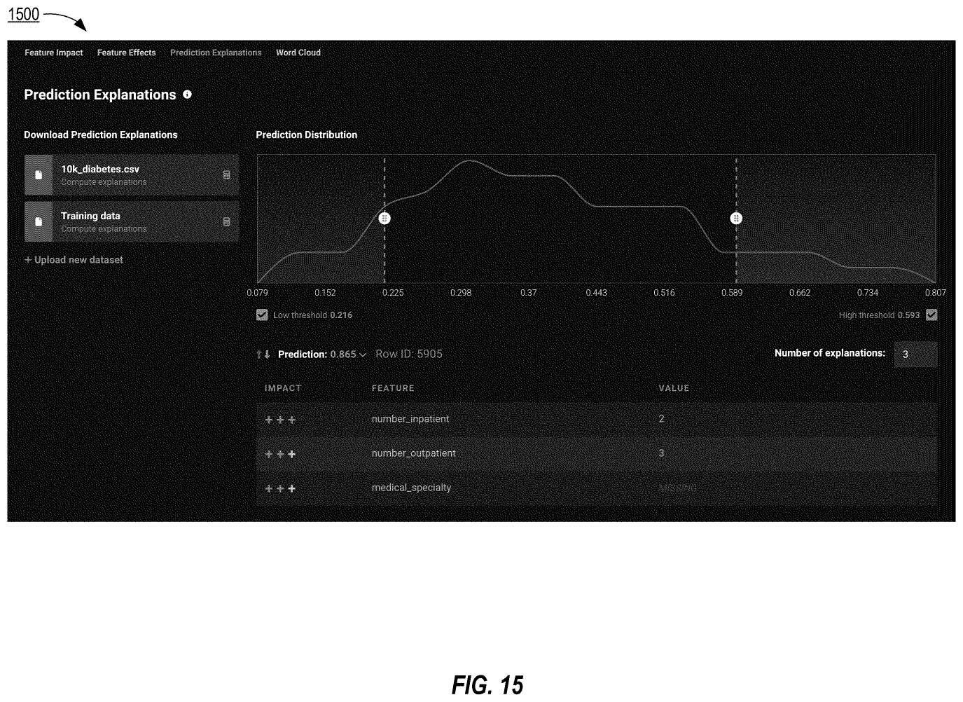

FIG. 15 is an illustration of an example user interface 1500 for generating prediction explanations. As shown in this example, the user interface includes a project selector on the left to allow users to select a particular data set or prediction as well as select a particular row of data, representing a particular loan. User interface 1500 also shows an overall distribution of predictions for the data set, which can help analysts determine whether a particular value for the target variable associated with the entry is unusually high or low for the data set and/or define high or low values outside of which data is flagged for further review. Just below the prediction distribution graph, user interface 1500 includes an interface field allowing a user to set a number of explanations to generate for selected features, which are indicated at the bottom of user interface 1500. A user can select a specific feature to cause the system to generate prediction explanations for that specific feature and that specific row. Additionally or alternatively, a user may select multiple features to cause the system to generate explanations for each feature, or the system may include a default number of top features for which to generate explanations. Each feature shown in the feature selection region shows a reason code in the column labeled “impact”, a feature ID or name in the column labeled “feature”, and a value for the feature in the column labeled “value”.

In this example, reason codes may be a combination of directionality of impact (i.e., whether a particular value of a particular feature contributed to an increase or decrease in the target variable) along with a magnitude of the feature's effect and may sometimes be referred to as qualitative strength indicators. For example, reason codes or qualitative strength maps could involve “+++” to indicate that a value strongly increases the target variable, while a reason code of “−−−” indicates that a specific feature value significantly decreases the target variable. Varying numbers of “+” or “−” symbols can refer to any intermediate qualitative strength of the feature value, and a default interpretation of a null or zero reason code can be defined as “unclear or limited impact” on the target variable. As a specific example, for a model that predicts patient readmissions, a feature named “purpose” with a value of “small_business” can have a reason code of “+++” indicating that the particular loan purpose (in this case, a small business loan) greatly contributed to the model's prediction that this particular loan is more likely to default. Although this example uses “+” and “−” symbols as reason codes, reason codes can be any suitable shorthand for representing the relative impact a particular feature and value had on a model's predictions.

Reason code summaries can be created in a variety of ways. In some embodiments, reason code summaries can be created programmatically, or without the use of a generative model. In these embodiments, each reason code can be mapped to language describing the qualitative strength of the feature and value. The feature label can likewise be translated into prose or natural language using the data dictionary, and this information can then be inserted into a template to generate a prose description of each reason code. In other embodiments, reason codes can be inserted into a prompt template and provided to a generative model to create prose descriptions of the reason codes.

In some embodiments, a generative model can be configured to generate a specific number of hypotheses or explanations for each reason code, or this information can be included as static text in the prompt template used to create the prompt for causing the generative model to create prediction explanations 1430. For example, a prompt template could be configured to prompt a generative model to produce three, four, or five prediction explanations for each feature.

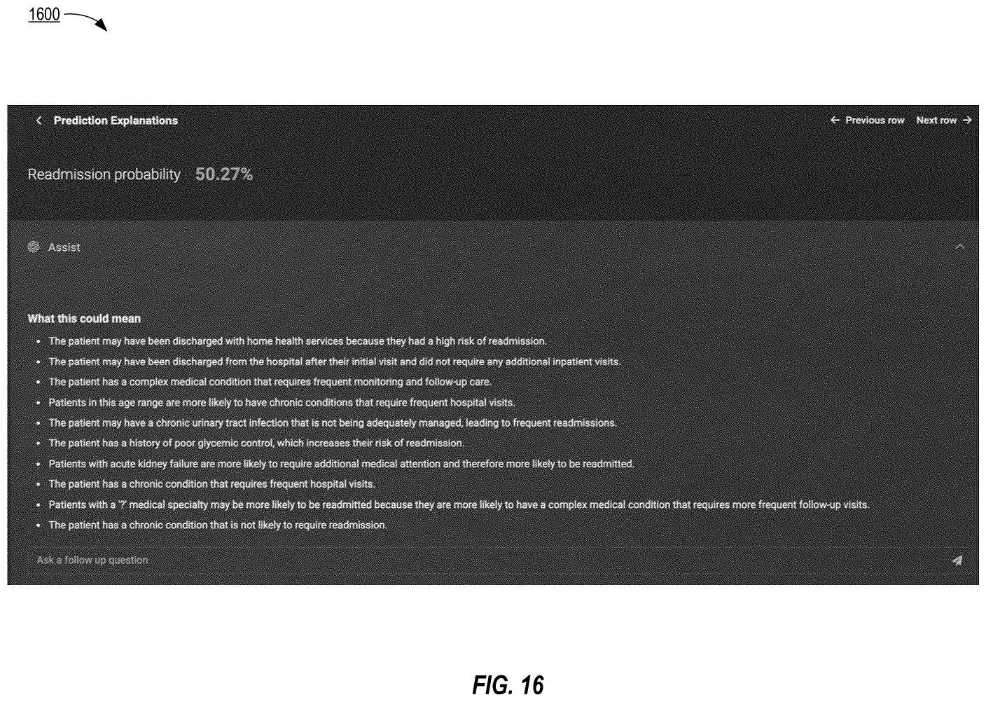

Once the generative model has generated prediction explanations for each reason code, these prediction explanations may then be assembled into prediction explanation summaries, detailing explanations associated with each reason code. FIG. 16 is an illustration of an example user interface 1600 showing a prediction explanation summary for a single prediction. In this example, a predictive model has estimated that a particular patient has a 50.27% chance of being readmitted to the hospital within 30 days. The systems and methods described herein have then generated a number of explanations for how the predictive model arrived at the various conclusions. User interface 1600 also includes an input field for a user to input follow-up questions that may be handled according to the query/response process described above.

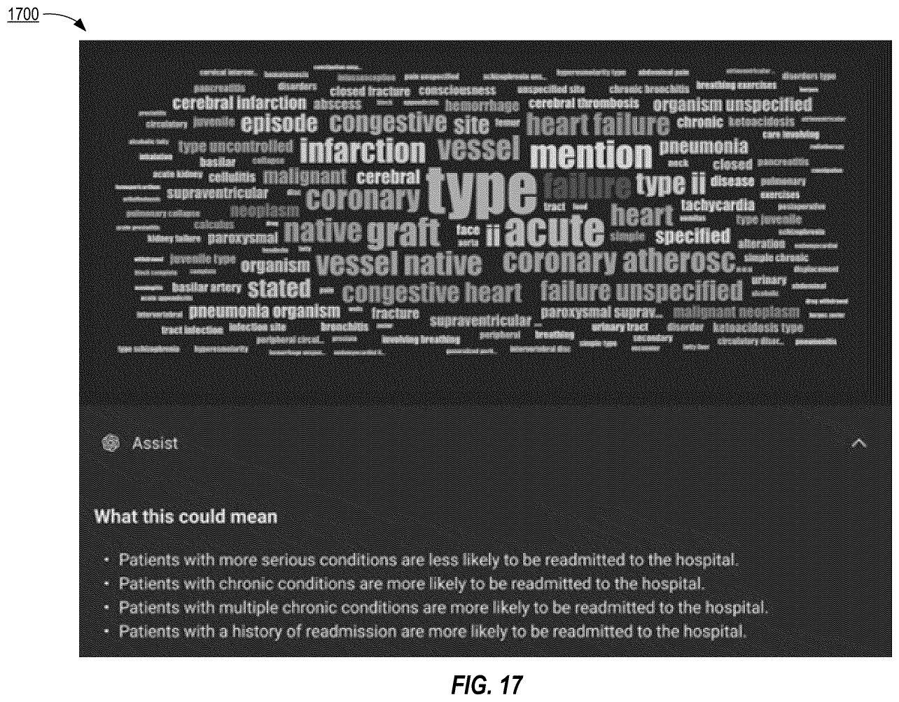

FIG. 17 is an illustration of an example user interface 1700 displaying a word cloud along with a number of relationships derived according to the systems and methods described above. Word cloud plots such as the one displayed by user interface 1700 may be derived from analysis data according to words that appear as field values. Additionally or alternatively, the word cloud may be derived from any other suitable data, such as original input data that was used to generate the analysis data or other derivatives of the original and/or analysis data. In the example of FIG. 17, the displayed word cloud displays words derived from an analysis of 30-day patient readmission rates, showing words that appear in records or entries of the analysis. In this example, words are plotted according to frequency and importance. Words that appear more frequently in the data set are assigned a higher frequency value and are displayed with a larger font size. Meanwhile, words that more tightly correlate with the target variable of 30-day readmission rate are afforded a higher importance value and are displayed closer to the center of the word cloud. In some embodiments, word cloud data can be stored in tabular form. For example, columns of a table for storing word cloud data may include the word, a frequency of the word, and a relative importance of the word. Rows of the table may correspond to words or phrases in the word cloud. This data can then be rendered for display via a user interface, such as user interface 1700.

In some embodiments, the systems and methods described herein can generate project-specific programming code (e.g., source code) to assist users in using generative models (e.g., using generative models for the tasks described herein, or for any other suitable task). Some generative models, including language models such as GPT-4, are trained on large quantities of programming code and related information, such as code derived from public repositories, commercially available APIs, etc. A user can submit, via a user interface, a request (e.g., natural language request) for a generative model to generate a block of programming code (e.g., a request to automate one or more data analyses and/or machine learning tasks). In some examples, the user-submitted request may be augmented with additional context such as context data 210 and/or project specific information such as information from data dictionary 212 to create a contextualized prompt that can be provided to a generated model to prompt the generative model to generate project-specific code. In some embodiments, this information can be combined using a prompt template.

In further embodiments, previous user-submitted text (e.g., previous code requests) and/or previously generated code can be incorporated into the contextualized prompt, allowing a user to iteratively improve upon code previously generated by the generative model. For example, a user may submit a request to for code suitable for deploying a generative model to generate relationship-explanation pairings for a data set relating to 30-day patient readmission rates. Using a prompt template, some embodiments may combine context data relating to 30-day patient readmission rates and a data dictionary from a related project to add project context to a prompt provided to a model to prompt the model to generate the requested code. The user may then submit a follow-up request, such as “Please add documentation comments to the previously provided code.” Some embodiments may incorporate the generated code, the previous request, and any other suitable context data to create a new prompt, thereby causing the generative model to iterate on the previously generated code and add documentation comments as the user requested. While adding comments is one example of code generation iteration that could be accomplished using some embodiments, other varieties of code iteration and refinement could be accomplished.

In some embodiments, the code generation principles described herein may be used to select and deploy one or more machine learning models corresponding to a request received via a user interface and/or device. Some embodiments can, for example, automatically select a supervised machine learning model based on one or more characteristics of the requested data set and/or the requested task/outcome, including content of a data set. For example, some embodiments can automatically identify an appropriate model to respond to input describing a request for assistance identifying and deploying an appropriate model for a given user's data set and/or attributes. For example, some embodiments may automatically identify a model based on a user's metadata in response to receiving an input such as “how can I build a model to predict readmission?”

In some embodiments, a system can include or access multiple models, data sets, metadata, code repositories, application programming interfaces (APIs), etc., to enable it to automatically interpret natural language inputs, received via a client device or user interface, that request a set of computer-executable operations (e.g., to perform the specified data science task or otherwise perform the specified machine learning functionality). For example, system 100 illustrated in FIG. 1 may optionally include a request management engine (not illustrated in FIG. 1). Such a request management engine can determine a task, operation, outcome, or analysis (or identify a data set) for a given request described in a text string received from the client device 140 or otherwise input by a user (e.g., input via user interface 142). As a specific example, a request management engine may determine, or identify, a specific data science task or operation indicated for a request (e.g., described in a string of natural language text received via user interface 142). More specifically, upon receiving an input string for a request that states, “Merge my patient data and treatment data [from a third party cloud data repository] together, and create a new feature called readmission that is True if patient_code is 5” the request controller may identify each of the different tasks and/or operations indicated by the natural language input received from the user. Thus, the request management engine may, in some embodiments, assign a different request to each individual task and/or operation indicated by that input text (e.g., assign a first request for the portion of the input stating “merge my patient data and treatment data from [a third party cloud repository] together,” and assign a second, different, request to the portion of the input stating “create a new feature called readmission that is True if patient_code is 5”).

Additionally or alternatively, the request management engine may assign a single request to each string of text received via the user interface 142 and track performance and completion of the different tasks and/or operations of the request for that string as elements included in the overall request indicated by the natural language input are received by the data processing system (e.g., via the network 101 and client device 140).

In some embodiments, the request management engine may perform one or more post-processing steps. Post-processing can refer to steps taken after one or more outputs responsive to a request have been received and/or determined, such as after data transformations or model outputs. In other examples, post-processing steps can include, for example, calibration of a model and/or data set used to generate one or more computer-executable operations responsive to a received natural language request.

In some embodiments, the system may further include a context engine that can identify the relevant model(s), data set(s), attribute(s) (e.g., of one or more features of a data set and/or machine learning model(s) associated with those feature(s), etc.), user metadata, and a Software Development Kit (“SDK”) associated with one or more computer-executable operation(s) responsive to the request. In some embodiments, the SDK data can include one or more data science programming language(s) and/or associated programming language data (e.g., programming libraries, code block guidelines, code blueprints, features and/or attribute(s), custom code blocks previously input by a user, etc.) that are associated with one or more of the string of natural language received by the data processing system (or the request described therein), a data science notebook of the user, code blocks (e.g., functions, commands, etc.) that are commonly used for programming a requested data science task and/or machine learning model. More specifically, in some embodiments, the user metadata can comprise data and other information known for the user (or the data science notebook and/or organization) associated with a request, such as, one or more cloud data repositories (e.g., a third-party data set or cloud data repository, that the data processing system accesses (e.g., queries, calls, etc.) over the network). Additionally, the user metadata may include requests previously received by the data processing system for the same user, or that are associated with the same data science notebook and/or the same organization. The user metadata may, therefore, include previously received strings of natural language request for automated generation of one or more computer-executable operations and may also include the corresponding computer-executable operation(s), and/or data, that was automatically generated by the system in response to those request(s).

Additionally, the context engine may, in some embodiments, determine the appropriate model, programming language, data set, attribute(s), and the like, for the appropriate set of computer-executable operations to be automatically generated in response to the request described by the received string of natural language. For example, the data processing system may receive a natural language request to merge two features of a data set, which the system can process based on user metadata, identified by the context engine, indicating that the relevant data source(s) for the request are, in fact, third-party cloud data repositories (e.g., with access occurring via an API for the third-party cloud storage).

In some embodiments, the system can include a prompt constructor capable of generating a completion prompt, or an automation prompt, to be provided as an input to a generative model, which is the input used by the model(s) to generate the set of computer-executable operations responsive to the received natural language request (e.g., generate a string of text for the input to the model(s) 132). For example, the prompt constructor can operate to parse the received string of natural language text into one or more separate completion prompts to be provided to generative model engine 130, which may include appending the output from the generative model for a first such completion prompt to the subsequent completion prompt (e.g., generate the responsive computer-executable operations using an iterative performance of the automated process; such that data processing system 110 may provide a second completion prompt comprising output(s) generated by the generative model engine from a completion prompt previously generated by data processing system 110 and provided as an input to generative model engine 130).

Additionally, in some embodiments, the prompt constructor can determine appropriate natural language and/or formatting for the string of text included in the completion prompt provided to the generative model engine. For example, the data processing system 110 and/or the prompt constructor can determine the appropriate amount of user metadata, attribute(s), and/or other information to include (and the formatting for how the information will appear in the prompt string provided for the input to generative model engine 130). More specifically, in one example, the prompt constructor can determine the appropriate formatting, based on the API and user metadata, for a completion prompt that includes natural language for a request to build a model to predict the probability of attribute(s) and/or specified event(s) (e.g., a probability of patient readmission or probability of default on an account).

Additionally, in some embodiments, the prompt constructor can receive one or more metric(s) (e.g., standard deviation, median, mean, maximum, minimum, variance, etc.) and/or metadata (e.g., one or more associated hypothesis, explanations, prediction value(s) (e.g., target variables), previous API Queries and the associated outputs provided by generative models, algorithm(s) and/or scripts for generation of natural language sentence(s) of completion prompt(s) based on previous inputs/outputs, etc.) corresponding to any data related to the generation of a completion prompt (or the characteristics of a completion prompt and/or API Query for generative model engine 130), including, for example, metrics and/or metadata for one or more model(s), data set(s), attribute(s) and/or feature(s) (e.g., type(s) of input data, dimensionality of input data, type(s) of output data, dimensionality of output data, etc.), parameters, machine learning task(s), data guardrails, blueprints, scripts and/or custom code block(s), commands, and/or any other information received for the generation of one or more characteristics of a completion prompt (or an associated API Query)).

Furthermore, in some embodiments, the prompt constructor can utilize the received metric(s) and/or metadata corresponding to the request to determine the scope of the domain that the prompt constructor will use to generate a completion prompt (or any of its characteristics). For example, in some embodiments, the prompt constructor can prepend one or more phrases and/or natural language sentence(s) to the received string and/or a generated completion prompt to identify one or more of the following, including characteristic(s), boundaries, values, minimums, maximums, predictors, prediction data, and/or other relevant attribute(s) of the metric(s) and/or metadata received by the prompt constructor and used to generate the completion prompt provided to generative model engine 130. The prompt constructor can, therefore, determine a domain for use in generating a completion prompt based on any of the information that is described above with reference to the prompt constructor, including one or more data set(s), metric(s), attribute(s), model(s), metadata, parameter(s), code block(s), hypothesis, previous outputs from generative model engine 130 (and/or its model(s) 132), one or more hypotheses and/or prediction values, and the like, as described above for the operation of the prompt constructor to automatically generate the completion prompt.

### Model Development System

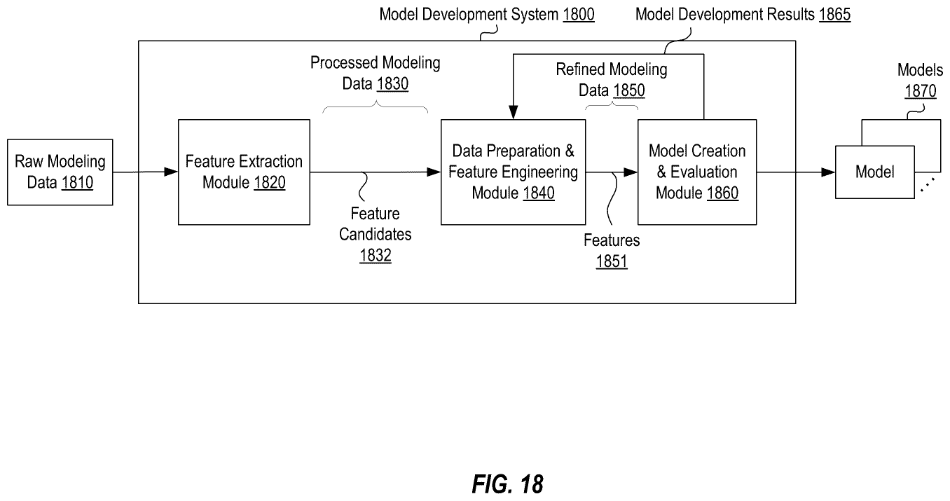

Referring to FIG. 18, a model development system 1800 may include a feature extraction module 1820, a data preparation and feature engineering module 1840, and a model creation and evaluation module 1860. In some embodiments, the model development system 1800 receives raw modeling data 1810 and uses the raw modeling data to develop (e.g., automatically develop) one or more models 1870 (e.g., machine learning models, etc.) that solve a problem in a domain of data analytics. The raw modeling data 1810 may include numerical data, categorical data, time-series data, tabular data, non-tabular data (e.g., image data, textual data, natural language data, speech data, auditory data, spatial data, etc.), or any other suitable type of data. Some embodiments of the components and functions of the model development system 1800 are described in further detail below.

In some embodiments, the feature extraction module 1820 performs data pre-processing and feature extraction on the raw modeling data 1810, and provides the extracted features to the data preparation and feature engineering module 1840 as feature candidates 1832 within a processed modeling dataset 1830. The feature extraction module 1820 may extract one or more features having a location data type, an image data type, a numerical data type, a text data type (e.g., a structured text data type or an unstructured (“free”) text data type), a categorical data type, or any other suitable data type. In some embodiments, the feature extraction module uses one or more pre-trained and/or fine-tunable data processing models to extract features from the raw modeling data.

The data preparation and feature engineering module 1840 may perform data preparation and/or feature engineering operations on the processed modeling data 1830. The data preparation operations may include, for example, characterizing the input data. Characterizing the input data may include detecting missing observations, detecting missing variable values, and/or identifying outlying variable values. In some embodiments, characterizing the input data includes detecting duplicate portions of the modeling data 1830 (e.g., observations, spatial objects, images, etc.). If duplicate portions of the modeling data 1830 are detected, the model development system 1800 may notify a user of the detected duplication.

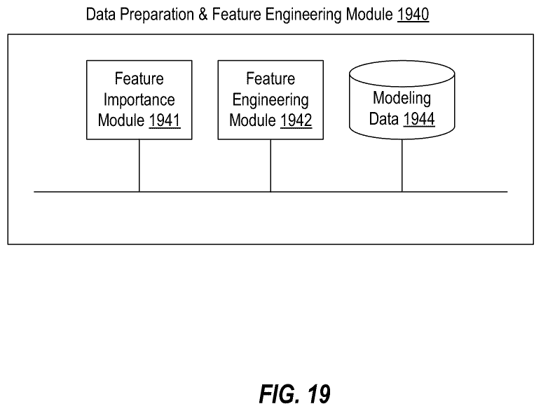

Referring to FIG. 19, some embodiments of the data preparation and feature engineering module 1840 may include a feature importance module 1941 and/or a feature engineering module 1942, each of which may be configured to operate on modeling data 1944. In some embodiments, the operations performed by the data preparation and feature engineering module 1940 transform the modeling data 1944 from the processed modeling data 1830 into refined modeling data 1850.

In some embodiments, the feature importance module 1941 determines the “feature importance” (sometimes referred to simply as the “importance”) of one or more features of the modeling data 1944 (e.g., feature candidates 1832, other features engineered from the processed modeling data 1830, etc.) to a particular model. A candidate feature's “importance” to a model may indicate the extent to which the model relies on the feature (e.g., relative to other candidate features) to generate accurate estimates of a target variable's value. Any suitable techniques may be used to determine a feature's importance. In some embodiments, feature importance metrics determined by a feature importance module 1941 may include, without limitation, univariate feature importance, feature impact, permutation importance, and SHapley Additive exPlanations (“SHAP”). These metrics and some embodiments of techniques for assessing (or “scoring”) the feature importance of various types of features according to these metrics are described below.

In some embodiments, the feature importance module 1941 may determine univariate feature importance scores for one or more (e.g., all) the features of a dataset during the exploratory data analysis phase of the model development process. In some embodiments, permutation importance techniques are generally used to determine the importance of tabular features.

In general, the “univariate feature importance” of a feature F for a modeling problem P is an estimate of the correlation between the target of the modeling problem P and the feature F. Any suitable technique may be used to determine the univariate feature importance of tabular features.

In general, the “feature impact” (e.g., feature importance) of a feature F for a model M is an estimate of the extent to which the feature F contributes to the performance (e.g., accuracy) of the model M. The feature impact of a feature F may be “model-specific” or “model-dependent” in the sense that it may vary with respect to two different models M1 and M2 that solve the same modeling problem (e.g., using the same feature set).

In general, the feature impact of a non-tabular feature F for a trained model M may be determined by (1) using the model M to generate one set of inferences for a validation dataset in which the data samples contain the actual values of the feature F, (2) using the model M to generate another set of inferences for a version of the validation dataset in which the values of the feature F have been altered to destroy (e.g., reduce, minimize, etc.) the feature's predictive value, and (3) comparing the performance P1 (e.g., accuracy) of the first set of inferences to the performance P2 (e.g., accuracy) of the second set of inferences. In general, as the difference between P1 and P2 increases, the feature impact of the feature F increases.

In some embodiments, the feature impact of one or more (e.g., all) features of the model's feature set may be determined in parallel. In some cases, the feature impact of a feature F may be negative, indicating that the model's reliance on the feature decreases the model's performance. In some embodiments, features with negative feature impact may be removed from the feature set, and the model may be retrained using the reduced feature set.

In some embodiments, after the feature impacts of one or more features of interest (e.g., all features) have been determined, the feature impacts may be normalized. For example, the feature impacts may be normalized so that the highest feature impact is 100%. Such normalization may be achieved by calculating normalized_F_{IMP}(Fi)=raw_F_{IMP}(Fi)/max(raw_F_{IMP}(all Fi)) for each feature Fi. In some embodiments, the N greatest normalized feature impact scores may be retained, and the other normalized feature impact scores may be set to zero to enhance efficiency. The threshold N may be any suitable number (e.g., 100, 500, 1,000, etc.).

In some embodiments, the feature importance module 1941 may determine feature impact scores for one or more (e.g., all) the features of a dataset during the model creation and evaluation phase of the model development process. In some embodiments, the feature importance module may determine feature impact scores for any suitable type(s) of feature(s).

In some embodiments, the feature impact scores determined for various features (e.g., features of the same type, features of different types, tabular features, non-tabular features, image features, non-image features, spatial features, non-spatial features, etc.) can be quantitatively compared to each other. This comparison may help the user understand the importance of including various non-tabular data elements (e.g., images) in the dataset. Likewise, the model-specific feature impact scores of a particular feature (e.g., a non-tabular feature) for a set of models may be compared. This comparison may help the user understand which models are doing a good job exploiting the information represented by the feature and which are not.

In some embodiments, the feature engineering module 1942 performs feature engineering operations on the modeling data 1944. These feature engineering operations may include, for example, combining two or more features and replacing the constituent features with the combined feature; extracting a new feature from the constituent features; dropping features that contain low variation (e.g. are mostly missing, or mostly take on a single value); extracting different aspects of date/time variables (e.g., temporal and seasonal information) into separate variables; normalizing variable values; infilling missing variable values; one hot encoding; text mining; etc.

In some embodiments, the feature engineering module 1942 may perform spatially-aware feature engineering on the modeling data 1944. For example, the feature engineering module 1942 may derive “solitary” spatial features representing geometric attributes and/or spatial statistics associated with individual (solitary) spatial objects (each of which may include multiple geometric elements). In addition or in the alternative, the feature engineering module 1942 may derive “relational” spatial features of spatial observations based on the spatial relationships between spatial observations.

In some embodiments, the feature engineering module 1942 performs feature engineering on image features in the modeling data 1944. For example, the feature engineering module 1942 may extract a new feature (e.g., average pixel intensity, size of an image in bytes, width and/or height of an image in pixels, color histogram of an image, etc.) from the constituent image features. As another example, the feature engineering module 1942 may rotate, scale, crop, flip, blur, or otherwise modifying image features to create new image features. Any suitable image feature engineering techniques may be used, including (without limitation) the techniques described below.

With respect to image data, exploratory data analysis operations may include, without limitation, automated assessment of image data quality (e.g., determining the feature importance of the candidate image features, detecting duplicates in the image data using image similarity techniques, detecting missing images, detecting broken image links, detecting unreadable images, etc.), and target-aware previewing of image data (e.g., displaying examples of images per class for classification problems, automated drilldown into images associated with different target subranges for regression problems, etc.). The feature importance of a candidate image feature may be, for example, the feature's univariate feature importance as discussed above. If a missing image is detected (e.g., no link to an image is specified for an image variable of a data sample), the model development system may automatically impute a default image (e.g., an image in which all pixels are the same color, for example, black) for the image variable of the data sample. If a broken image link (e.g., a link to an image specified for an image variable of data sample, but the specified file does not exist at the specified location) or an unreadable image (e.g., specified image exists but is unreadable or corrupted) is detected, the model development system may notify the user, thereby giving the user an opportunity to correct the error or to instruct the system to substitute a default image for the broken image link/unreadable image.

In some instances, the model development system 1800 automatically assembles multiple data sources into one modeling table. In such instances, automatic exploratory data analysis may include, without limitation, identifying the data types of the input data (e.g., numeric, categorical, date/time, text, image, location (geospatial), etc.), and determining basic descriptive statistics for one or more (e.g., all) features extracted from the input data. The results of such exploratory data analysis may help the user verify that the system has understood the uploaded data correctly and identify data quality issues early.

In some embodiments, the data preparation and feature engineering module 1940 also performs feature selection operations (e.g., dropping uninformative features, dropping highly correlated features, replacing original features with top principal components, etc.). The data preparation and feature engineering module 1840 may provide refined modeling data 1850 with a curated (e.g., analyzed, engineered, selected, etc.) set of features 1851 to the model creation and evaluation module 1860 for use in creating and evaluating models. In some embodiments, the data preparation and feature engineering module 1840 determines the importance (e.g., feature importance) or feature impact of the individual feature candidates (selected from, e.g., feature candidates 1832) and/or individual engineered features derived therefrom, and selects a subset of those feature candidates (e.g., the N most important feature candidates, all feature candidates having importance scores above a threshold value, etc.) as the features 1851 used by the model creation and evaluation module 1860 to generate and evaluate one or more models.

In some embodiments, the data preparation and feature engineering module 1840 may use the feature importance scores generated by the feature importance module 1941 to determine which features to prune from the dataset, which features to retain for further modeling tasks, and/or which features to select for feature engineering operations. For example, the data preparation and feature engineering module 1840 may prune “less important” features from the modeling data 1944. In this context, a feature may be classified as “less important” if the feature importance score of the feature is less than a threshold value, if the feature has one of the M lowest feature importance scores among the features in the dataset, if the feature does not have one of the N highest feature importance scores among the features in the dataset, etc. As another example, the system may engineer new features (e.g., “derived features” or “engineered features”) from “more important” features in the dataset. In this context, a feature may be classified as “more important” if the feature's importance score is greater than a threshold value, if the feature has one of the N highest importance scores among the features in the dataset, if the feature does not have one of the M lowest importance scores among the features in the dataset, etc. In addition or in the alternative, the data preparation and engineering module 1840 may allocate more resources to feature engineering tasks involving the more important features of the dataset.

In some embodiments, the data preparation and feature engineering module 1840 may present (e.g., display) an evaluation of a dataset to a user of a model development system 1800, and the presented evaluation may include the feature importance scores of the dataset's features (e.g., including but not limited to any location features) and/or information derived therefrom. For example, for one or more models, the data preparation and feature engineering module 1840 may (1) identify “more important” and/or “less important features”, (2) display the feature importance scores of the features, and/or (3) rank the features by their feature importance scores.

The model creation and evaluation module 1860 may create one or more models and evaluate the models to determine how well they solve the data analytics problem at hand. In some embodiments, the model creation and evaluation module 1860 performs model-fitting steps to fit models to the training data (e.g., to the features 1851 of the refined modeling data 1850). The model-fitting steps may include, without limitation, algorithm selection, parameter estimation, hyperparameter tuning, scoring, diagnostics, etc. The model creation and evaluation module 1860 may perform model fitting operations on any suitable type of model, including (without limitation) decision trees, neural networks, support vector machine models, regression models, boosted trees, random forests, deep learning neural networks, k-nearest neighbors models, naïve Bayes models, etc. In some embodiments, the model creation and evaluation module 1860 performs post-processing steps on fitted models. Some non-limiting examples of post-processing steps may include calibration of predictions, censoring, blending, choosing a prediction threshold, etc.

In some embodiments, the data preparation and feature engineering module 1840 and the model creation and evaluation module 1860 form part of an automated model development pipeline, which the model development system 1800 uses to systematically evaluate the space of potential solutions to the data analytics problem at hand. In some cases, results 1865 of the model development process may be provided to the data preparation and feature engineering module 1840 to aid in the curation of features 1851. Some non-limiting examples of systematic processes for evaluating the space of potential solutions to data analytics problems are described in U.S. patent application Ser. No. 15/331,797 (now U.S. Pat. No. 10,366,346).

During the process of evaluating the space of potential modeling solutions for a data analytics problem, some embodiments of the model creation and evaluation module 160 may allocate resources for evaluation of modeling solutions based in part on the feature importance scores of the features in the dataset (e.g., refined modeling data 1850) representing the data analytics problem. In general, the model creation and evaluation module 1860 may select or suggest potential modeling solutions that are predicted to be suitable or highly suitable for a dataset. When determining the suitability of a predictive modeling procedure for a data analytics problem, the model creation and evaluation module 1860 may treat the characteristics of the more important features of the dataset as the characteristics of the data analytics problem. In this way, the model creation and evaluation module 1860 may generate “suitability scores” for potential modeling solutions, such that the suitability scores are tailored to the more important features of the dataset. The model creation and evaluation module may then allocate computational resources to model training and evaluation tasks based on those suitability scores. Thus, tailoring the suitability scores to the more important features of the dataset may result in resources being allocated to the evaluation of potential modeling solutions based in part on feature importance scores.

In some embodiments, the model creation and evaluation module 1860 selects models for blending based on the feature importance scores and blends the selected models. The model creation and evaluation module 1860 may use any suitable technique to select models for blending. For example, “complementary top models” may be selected for blending. In this context, “complementary top models” may include high-performing models that achieve their high performance (e.g., high accuracy) through different mechanisms. The model creation and evaluation module 1860 may classify a model as a “top” model if a score representing the model's performance is greater than a threshold, if the model has one of the N highest scores among the fitted models, if the model does not have one of the M lowest scores among the fitted models, etc. The model creation and evaluation module 1860 may classify two models as “complementary” models if (1) the most important features for the models (e.g., the features having the highest feature importance scores for the models) are different, or (2) a feature that has high importance to the first model has low importance to the second model, and a feature that has low importance to the first model has high importance to the second model. In this context, a feature may have “high importance” to a model if the feature has a high feature importance score for the model (e.g., the highest feature importance score, one of the highest N feature importance scores, a feature importance score greater than a threshold value, etc.). In this context, a feature may have “low importance” to a model if the feature has a low feature importance score for the model (e.g., the lowest feature importance score, one of the lowest N feature importance scores, a feature importance score lower than a threshold value, etc.). In some embodiments, the model creation and evaluation module 1860 may use the above-described classification techniques to select two or more complementary top models for blending. In some cases, blending complementary top models may yield blended models with very high performance, relative to the component models. By contrast, blending non-complementary models may not yield blended models with significantly better performance than the component models.

In some embodiments, a model creation and evaluation module 1860 may present (e.g., display) evaluations of models 1870 to users. Such model evaluations may include feature importance scores of one or more features for one or more models (e.g., the top models). Presenting the feature importance scores to the user may assist the user in understanding the relative performance of the evaluated models. For example, based on the presented feature importance scores, the user (or the system) may identify a top model M that is outperforming the other top models, and one or more features F that are important to the model M but not to the other top models. The user may conclude (or the system may indicate) that, relative to the other top models, the model M is making better use of the information represented by the features F.

The model development system 1800 may facilitate the use of the above-referenced solution-space evaluation techniques to evaluate potential solutions to data analytics problems involving spatial data. Optionally, these data analytics problems may also involve non-spatial data (e.g., image data).

In some cases, the model generated by the creation and evaluation module 160 includes a gradient boosting machine (e.g., gradient boosted decision tree, gradient boosted tree, boosted tree model, any other model developed using a gradient tree boosting algorithm, etc.). Gradient boosting machines are generally well-suited to data analytics problems involving heterogeneous tabular data.

In some cases, the model generated by the creation and evaluation module 160 includes a feed-forward neural network, with zero or more hidden layers. Feed forward neural networks are generally well-suited to data analytics problems that involve combining data from multiple domains (e.g., spatial data and image data; spatial data and numeric, categorical, or text data, etc.), pairs of inputs from the same domain (e.g., pairs of spatial datasets, pairs of images, pairs of text samples, pairs of tables, etc.), multiple inputs from the same domain (e.g., spatial datasets, sets of images, sets of text samples, sets of tables, etc.), or combinations of singular, paired, and multiple inputs from a variety of domains (e.g., spatial data, image data, text data, and tabular data).

In some cases, the model generated by the creation and evaluation module 160 includes a regression model, which can generally handle both dense and sparse data. Regression models are often useful because they can be trained more quickly than other models that can handle both dense and sparse data (e.g., gradient boosting machines or feed forward neural networks).

In some embodiments, the model development system 1800 enables highly efficient development of solutions to data analytics problems involving spatial data. Existing techniques for developing spatial models are generally inefficient and expensive, and do not always yield optimal solutions to the problems at hand. In contrast to the machine learning domain, in which tools for model development have become increasingly automated over the last decade, techniques for developing spatial models remain largely artisanal. Experts tend to build and evaluate potential solutions in an ad hoc fashion, based on their intuition or previous experience and on extensive trial-and-error testing. However, the space of potential solutions for spatial data analytics problems is generally large and complex, and the artisanal approach to generating solutions tends to leave large portions of the solution space unexplored.

In some embodiments, the model development system 1800 disclosed herein can systematically and cost-effectively evaluate the space of potential solutions for spatial data analytics problems. In many ways, the conventional approaches to solving spatial data analytics problems are analogous to prospecting for valuable resources (e.g., oil, gold, minerals, jewels, etc.). While prospecting may lead to some valuable discoveries, it is much less efficient than a geologic survey combined with carefully planned exploratory digging or drilling based on an extensive library of previous results.

In some embodiments, the model development pipeline tailors its search of the solution space based on the computational resources available to the model development system 100. For example, the model development pipeline may obtain resource data indicating the computational resources available for the model creation and evaluation process. If the available computational resources are relatively modest (e.g., commodity hardware), the model development pipeline may extract feature candidates 1832, select features 1851, select model types, and/or select machine learning algorithms that tend to facilitate computationally efficient creation and evaluation of modeling solutions. If the computational resources available are more substantial (e.g., graphics processing units (GPUs), tensor processing units (TPUs), or other hardware accelerators), the model development pipeline may extract feature candidates 1832, select features 1851, select model types, and/or select machine learning algorithms that tend to produce highly accurate modeling solutions at the expense of using substantial computational resources during the model creation and evaluation process.

An example of a model development system 1800 specifically configured to develop spatially-aware models 1870 has been described. More generally, the model development system 1800 receives raw modeling data 1810 and uses it to develop one or more models (e.g., spatially-aware machine learning models, etc.) that solve a problem in a domain of modeling or data analytics. The modeling data may include spatial data. Optionally, the modeling data may include tabular data (e.g., numeric data, categorical data, etc.). Optionally, the modeling data may include other non-tabular data (e.g., image data, natural language data, speech data, auditory data, and/or time series data).

### Model Deployment System

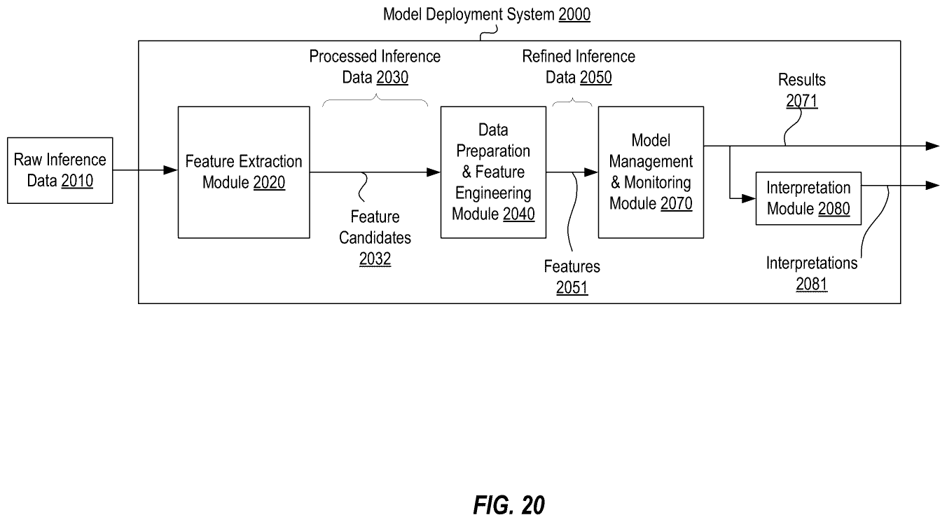

Referring to FIG. 20, a data analytics model deployment system 2000 may include a feature extraction module 2020, a data preparation and feature engineering module 2040, a model management and monitoring module 2070, and an interpretation module 2080. In some embodiments, the model deployment system 2000 receives raw inference data 2010 and processes it using one or more models (e.g., machine learning models, etc.) to solve a problem in a domain of data analytics. The inference data 2010 may include numerical data, categorical data, time-series data, tabular data, non-tabular data (e.g., image data, textual data, natural language data, speech data, auditory data, spatial data, etc.), or any other suitable type of data. Some embodiments of the components and functions of the model deployment system 2000 are described in further detail below.

The feature extraction module 2020 may perform data pre-processing and feature extraction on the raw inference data 2010, and provide the extracted features to the data preparation and feature engineering module 2040 as feature candidates 2032 within a processed inference dataset 2030. Some embodiments of suitable techniques for extracting feature candidates are described above with reference to feature extraction module 1820.

The data preparation and feature engineering module 2040 may perform data preparation and/or feature engineering operations on the processed inference data 2030. Some embodiments of suitable techniques for performing data preparation and feature engineering operations are described above with reference to data preparation and feature engineering module 1840. In some embodiments, the operations performed by the data preparation and feature engineering module 2040 transform the processed inference data 2030 into refined inference data 2050.

The model management and monitoring module 2070 may manage the application of a deployed model to the features 2051 of the refined inference data 2050, thereby solving the data analytics problem and producing results 2071 characterizing the solution. In some embodiments, the model management and monitoring module 2070 may track changes in data over time (e.g., data drift) and warn the user if excessive data drift is detected. In addition, the model management and monitoring module 2070 may be capable of retraining a deployed model (e.g., rerunning the model blueprint on new training data) and/or replacing a deployed model with another model (e.g., the retrained model). Retraining and/or replacement of a deployed model may be manually initiated by the user (e.g., in response to receiving a warning that excessive data drift has been detected) or automatically initiated by the model management and monitoring module 2070 (e.g., in response to detecting excessive data drift).

In some embodiments, the model management and monitoring module 2070 may present (e.g., display) evaluations of models to users. Such model evaluations may include feature importance scores of one or more features for one or more models. Presenting the feature importance scores to the user may assist the user in understanding the relative performance of the evaluated models. For example, based on the presented feature importance scores, the user (or the system) may identify a top model M that is outperforming the other top models, and one or more features F that are important to the model M but not to the other top models. The user may conclude (or the system may indicate) that, relative to the other top models, the model M is making better use of the information represented by the features F.

The interpretation module 2080 may interpret the relationships between the results 2071 (e.g., predictions) provided by the model deployment system 2000 and the portions of the inference data (e.g., spatial data and/or non-spatial data) on which those results 2071 are based and may provide interpretations (or “explanations”) 2081 of those relationships.

In some embodiments, the interpretation module 2080 may provide one or more of the following types of interpretations:
1. Feature importance plot. By deriving features from inference data and providing those features as inputs to data analytics models, some embodiments make it possible for the feature importance of features (e.g., features of the same or different types) to be quantified using the same technique, and thereby make it possible for the feature importance of different features to be directly compared. Some non-limiting examples of techniques for determining feature importance are described above with respect to univariate feature importance and feature impact.
2. Prediction explanation plot.
3. Word cloud.
4. User interface tools for “drilling down” into specific model inferences. In some embodiments, the interpretation module 2080 provides a user interface for drilling down into specific model inferences (e.g., erroneous model inferences). This user interface may enable the user to see the examples of inference data for which a specific target was predicted or for which the data sample had a specific ground truth value.

Some examples of a data dictionary (e.g., data dictionary 212) have been described. In some embodiments, a data dictionary is a set of descriptions of fields of a data set.

Some examples of analysis data (e.g., analysis data 204) have been described. In some embodiments, analysis data include data based on analysis of a data set and/or from analysis of one or more models. For example, analysis data can include feature impact data, which relates to both a data set and to a model (e.g., a model trained on the data set, or a model used to make inferences based on the data set). As another example, analysis data can include prediction explanations, which relate to individual predictions made by a model. In some examples, the data set on which analysis data are based can include training data or inference data. In some examples, the values of outcome variables in a data set can include ground-truth values, values predicted by a model, etc.

Some examples of analysis data have been described, including feature impact data, partial dependence data, word cloud data, and prediction explanations. In some examples, feature impact data, partial dependence data, and/or word cloud data provide information about a model in aggregate, whereas prediction explanations provide information about a specific prediction produced by a model.

Some examples of data sets including outcome variables have been described. In some examples, the outcome variable is a target variable (e.g., a value predicted by a supervised machine learning model). In some examples, the outcome variable is the output of an unsupervised machine learning model.

Some examples have been described in which visual quantitative data (e.g., plots) are transformed into text (e.g., a markdown table) and included in a prompt provided to a text-based generative model (e.g., a language model). In some examples, a multimodal generative model (e.g., a generative model capable of processing text data and one or more other types of data, such as image data or video data) is used, and visual quantitative data are included in a prompt provided to the multimodal generative model without transforming the visual quantitative data into text.

Some examples of systems that include or use generative models have been described. In some examples, the generative models may be commercial, off-the-shelf generative models (e.g., GPT-4). In some examples, the generative models have not been fine-tuned on dictionary prompts 206, summary prompts, 240, relationship prompts, 220, explanation prompts 226, and/or the other examples of prompts disclosed herein.

Some examples have been described in which systems provide descriptions of analysis data. In some examples, such descriptions of analysis data may be provided in connection with the operation of a model development system 1800 or a model deployment system 2000. For example, some embodiments of the techniques described herein can be applied to raw modeling data 1810, processed modeling data 1830, refined modeling data 1850, and/or any data generated by a model 1870. In some cases, the descriptions of data sets and/or models generated using the techniques described herein can be used to guide the development of models by the model development system 1800 or by a user thereof. As another example, some embodiments of the techniques described herein can be applied to raw inference data 2010, processed inference data 2030, refined inference data 2050, data produced by an interpretation module 2080, and/or any data generated by a model monitored or managed by model management and monitoring module 2070.

As may be appreciated from the above description, some examples of the systems and methods described herein can accept a quantitative analysis data set as an input and generate descriptions of various features of the data set as well as natural language hypotheses for why some trends may be present in the data. These descriptions and hypotheses may be generated via iterative interaction with generative models such as one or more language models (e.g., large language models (LLMs)), progressively transforming the data set into a collection of significant features and associated descriptions and/or explanations that can streamline analysis processes. These features can be extended to generate explanations for why a predictive model arrived at a specific prediction regarding, for example, the readmission probability of a specific patient in a medical context or the likelihood that a particular individual will default on a loan.

### Computer-Based Implementations

Techniques operating according to the principles described herein may be implemented in any suitable manner. Included in the discussion above are a series of flow charts showing the steps and acts of various processes for synthesizing natural language explanations of quantitative analysis data sets. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (i.e., as a single unit or separate units), or some of these functional facilities may not be implemented.

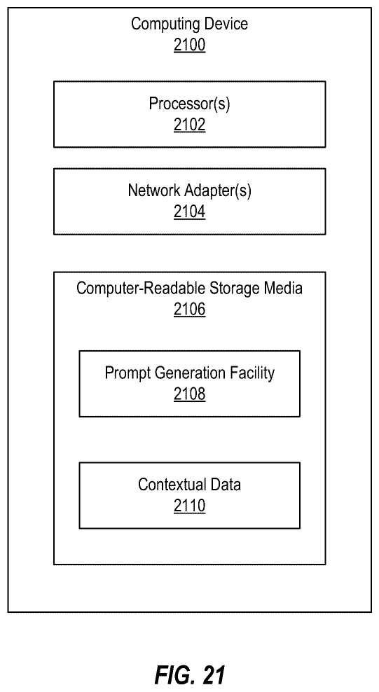

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 2106 of FIG. 21 described below (i.e., as a portion of a computing device 2100) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 1, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing devices (co-located or geographically distributed) dedicated to executing the techniques described herein, one or more Field-Programmable Gate Arrays (FPGAs) for carrying out the techniques described herein, or any other suitable system.

FIG. 21 illustrates one exemplary implementation of a computing device in the form of a computing device 2100 that may be used in a system implementing techniques described herein, although others are possible. It should be appreciated that FIG. 21 is intended neither to be a depiction of necessary components for a computing device to execute a prompt generation facility 2108 in accordance with the principles described herein, nor a comprehensive depiction. In some embodiments, a prompt generation facility may be configured to generate one or more prompts for use with a generative machine learning model as described above to generate completions that can be used in the process of synthesizing natural language explanations of an analytical data set. Prompt generation facility 2108 may include a prompt template library (e.g., prompt library 126 as illustrated in FIG. 1) by which prompt generation facility 2108 may convert a variety of inputs into prompts for generative models to cause those models to generate responses or completions in accordance with the principles described herein.

Computing device 2100 may comprise at least one processor 2102, a network adapter 2104, and computer-readable storage media 2106. Computing device 2100 may be, for example, a desktop or laptop personal computer, a personal digital assistant (PDA), a smart mobile phone, a server, a wireless access point or other networking element, or any other suitable computing device. Network adapter 2104 may be any suitable hardware and/or software to enable the computing device 2100 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 2106 may be adapted to store data to be processed and/or instructions to be executed by processor 2102. Processor 2102 enables processing of data and execution of instructions. The data and instructions may be stored on the computer-readable storage media 2106.

The data and instructions stored on computer-readable storage media 2106 may comprise computer-executable instructions implementing techniques which operate according to the principles described herein. In the example of FIG. 21, computer-readable storage media 2106 stores computer-executable instructions implementing various facilities and storing various information as described above. Computer-readable storage media 2106 may store contextual data 2110.

While not illustrated in FIG. 21, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A computer-implemented method, the method comprising:
obtaining analysis data indicating a plurality of results of analysis of a data set, the data set comprising a plurality of records, each record in the plurality of records including values of one or more respective fields and a value of an outcome variable;
obtaining context data that characterizes a use case of the data set;
generating, using one or more generative models, based on the analysis data and the context data, a data dictionary that associates each field in the one or more fields with a respective description of the field;
generating, using the one or more generative models, based on the analysis data and the data dictionary, a summary of the analysis data;
generating, using the one or more generative models, based on the context data, the summary of the analysis data, and the data dictionary, a description of a relationship between the outcome variable and at least a subset of the one or more fields;
generating, using the one or more generative models, based on the context data and the description of the relationship, one or more potential explanations for the relationship; and
outputting, for presentation via a user interface, output data based on the one or more potential explanations.

2. The computer-implemented method of claim 1, wherein the context data, the respective descriptions of the one or more fields of the data dictionary, the summary of the analysis data, the description of the relationship between the outcome variable and the subset of the one or more fields, and/or the one or more potential explanations comprise natural-language content.

3. The computer-implemented method of claim 1, wherein generating the data dictionary comprises:
constructing a first prompt that includes data indicating a first field selected from the one or more fields;
providing the first prompt to the one or more generative models; and
receiving a first completion from the one or more generative models, the first completion including a description of the first field.

4. The computer-implemented method of claim 3, wherein generating the data dictionary further comprises:
constructing a second prompt, wherein constructing the second prompt includes appending the first completion and data indicating a second field selected from the one or more fields to the first prompt;
providing the second prompt to the one or more generative models; and
receiving a second completion from the one or more generative models, the second completion including a description of the second field.

5. The computer-implemented method of claim 1, wherein generating the data dictionary comprises generating, using the one or more generative models, the respective descriptions of the one or more fields.

6. The computer-implemented method of claim 1, wherein the analysis data comprises a markdown table, the markdown table comprising tabular data represented in text, the tabular data being derived from plot data.

7. The computer-implemented method of claim 6, further comprising constructing a summary prompt including the markdown table and providing the summary prompt to the one or more generative models, wherein the generating of the summary of the analysis data using the one or more generative models is based on the markdown table.

8. The computer-implemented method of claim 1, wherein:
the analysis data comprises feature impact data describing, for each of the one or more fields, a respective extent to which the field affects the outcome variable; and
generating the summary of the analysis data comprises generating, based on the context data and an abbreviated representation of the feature impact data, a summary of the feature impact data.

9. The computer-implemented method of claim 1, wherein:
the analysis data comprises partial dependency data indicating, for each of the one or more fields, a direction and magnitude of a relationship between a change in the value of the respective field and a change in the value of the outcome variable; and
generating the summary of the analysis data comprises generating, based on the context data and an abbreviated representation of the partial dependency data, a summary of the partial dependency data.

10. The computer-implemented method of claim 1, wherein:
the analysis data comprises word cloud data indicating, for a plurality of words present in the analysis data, a frequency and an importance for each word in the plurality of words; and
generating the summary of the analysis data comprises generating, based on the context data and an abbreviated representation of the word cloud data, a summary of the word cloud data.

11. The computer-implemented method of claim 1, wherein generating the description of the relationship comprises:
constructing a first relationship prompt based on the context data, the summary of the analysis data, and the data dictionary, the first relationship prompt relating to the relationship between the outcome variable and the subset of the one or more fields;
providing the first relationship prompt to the one or more generative models; and
receiving a first completion from the one or more generative models, the first completion including a description of the relationship.

12. The computer-implemented method of claim 11, wherein the relationship is a first relationship, the subset of the one or more fields is a first subset of the one or more fields, the method further comprising:
constructing a second relationship prompt, wherein constructing the second relationship prompt includes appending the first completion to the first relationship prompt, the second relationship prompt relating to a second relationship between the outcome variable and a second subset of the one or more fields;
providing the second relationship prompt to the one or more generative models; and
receiving a second completion from the one or more generative models, the second completion including a description of the second relationship.

13. The computer-implemented method of claim 1, further comprising:
receiving a natural-language query regarding the analysis data;
constructing a first query prompt based on the context data, the summary of the analysis data, the one or more potential explanations, and the natural-language query; and
generating a response to the natural-language query, wherein generating the response includes providing the first query prompt to the one or more generative models and receiving a first completion including the response to the natural-language query from the one or more generative models,
wherein the output data includes the response to the natural-language query.

14. The computer-implemented method of claim 13, wherein the natural-language query is a first natural-language query, the method further comprising:
receiving a second natural-language query regarding the analysis data;
constructing a second query prompt based on the context data, the summary of the analysis data, the one or more potential explanations, the first natural-language query, the response to the natural-language query, and the second natural-language query; and
generating a response to the second natural-language query, wherein generating the response includes providing the second query prompt to the one or more generative models and receiving a second completion including the response to the second natural-language query from the one or more generative models.

15. The computer-implemented method of claim 1, wherein the output data comprises an executive summary comprising:
a summary of the description of the relationship between the outcome variable and the subset of the one or more fields; and
the one or more potential explanations for the relationship.

16. The computer-implemented method of claim 15, further comprising generating the executive summary, using the one or more generative models, wherein generating the executive summary comprises:
constructing, based on the context data, the data dictionary, and the description of the relationship, a first prompt including the description of the relationship between the outcome variable and the subset of the one or more fields;
providing the first prompt to the one or more generative models; and
receiving a first completion from the one or more generative models, the first completion including a summary of the description of the relationship.

17. The computer-implemented method of claim 16, wherein generating the executive summary further comprises:
constructing a second prompt including the summary of the description of the relationship;
providing the second prompt to the one or more generative models; and
receiving a second completion from the one or more generative models, the second completion including the one or more potential explanations of the first relationship.

18. A system comprising:
at least one processor; and
a computer-readable storage medium storing computer-executable instructions that, when executed by the at least one processor, cause the at least one processor to performing operations including:
obtaining analysis data indicating a plurality of results of analysis of a data set, the data set comprising a plurality of records, each record in the plurality of records including values of one or more respective fields and a value of an outcome variable;
obtaining context data that characterizes a use case of the data set;
generating, using one or more generative models, based on the analysis data and the context data, a data dictionary that associates each field in the one or more fields with a respective description of the field;
generating, using the one or more generative models, based on the analysis data and the data dictionary, a summary of the analysis data;
generating, using the one or more generative models, based on the context data, the summary of the analysis data, and the data dictionary, a description of a relationship between the outcome variable and at least a subset of the one or more fields;
generating, using the one or more generative models, based on the context data and the description of the relationship, one or more potential explanations for the relationship; and
outputting, for presentation via a user interface, output data based on the one or more potential explanations.

19. A computer-implemented method comprising:
receiving a request to generate computer-executable operations for use with machine learning on a data set;
identifying contextual data related the request based on metadata and the received request;
constructing a prompt including the contextual data and the request, wherein the contextual data identify a programming language and an application programming interface;
providing the prompt as input to an application programming interface for one or more generative models;
receiving, as output from the one or more generative models, the computer-executable operations corresponding to the request; and
outputting, for presentation via a user interface, output data representing the computer-executable operations.
